(19) United States
(12) Patent Application Publication
(10) Pub. No.: US 2026/0296934 A1
(43) Pub. Date: Oct. 1, 2026

(54) WATER TREATMENT METHOD AND WATER TREATMENT APPARATUS

(71) Applicant: ORGANO CORPORATION, Tokyo (JP)

(72) Inventors: Kento ISHII, Tokyo (JP); Hironori YUI, Tokyo (JP); Taichi YAMAMOTO, Tokyo (JP)

(73) Assignee: ORGANO CORPORATION, Tokyo (JP)

(21) Appl. No.: 19/475,854

(22) PCT Filed: Feb. 21, 2024
(86) PCT No.: PCT/JP2024/006316

§ 371 Date: Oct. 16, 2025

(30) Foreign Application Priority Data
Apr. 17, 2023 (JP) 2023-067347
Apr. 17, 2023 (JP) 2023-067348

(51) Int. Cl. C02F 3/00; C02F 3/30; C02F 101/16

(52) U.S. Cl. CPC C02F 3/006; C02F 3/305; C02F 2101/16; C02F 2203/006; C02F 2209/003; C02F 2209/14; C02F 2209/40; C02F 2209/44; C02F 2303/14

(57) ABSTRACT

A water treatment method includes a biological treatment step in which water to be treated that contains ammonia nitrogen dissolved therein is biologically treated in a biological treatment tank; a first measurement in which some of the water flowing into the biological treatment tank is caused to flow into a first measurement tank, the ammonia nitrogen dissolved in the water is transferred as ammonia gas to a gas phase in the first measurement tank, and the ammonia gas concentration C₁ is measured; and a second measurement in which some of the treated water that has undergone the biological treatment in the biological treatment tank is caused to flow into a second measurement tank, the ammonia nitrogen dissolved in the treated water is transferred as ammonia gas to a gas phase in the second measurement tank, and the ammonia gas concentration C₂ is measured.

### TECHNICAL FIELD

The present invention relates to a water treatment method and a water treatment apparatus for treating a water to be treated containing dissolved ammonia nitrogen.

### BACKGROUND

The flow of wastewater containing dissolved ammonia nitrogen flows into public water areas can cause eutrophication, and therefore ammonia nitrogen is typically removed using a biological treatment. In a nitrification/denitrification treatment, nitrifying bacteria oxidize the ammonia nitrogen to either nitrite nitrogen or nitrate nitrogen under aerobic conditions, and then denitrifying bacteria reduce the nitrite nitrogen and/or nitrate nitrogen to nitrogen gas under oxygen-free conditions in the presence of a hydrogen donor. These two microbial reactions can be expressed, for example, using the following chemical formulas.

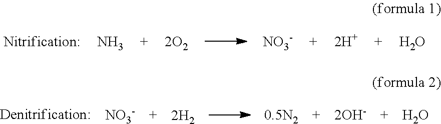

The nitrifying bacteria are highly sensitive to environmental fluctuations such as the temperature, pH and ammonia nitrogen concentration, and are prone to being inhibited by low concentrations of chemical substances. Further, because the nitrifying bacteria are autotrophic bacteria that use ammonia nitrogen or nitrite nitrogen as an energy source and inorganic carbon as a carbon source, they have a slow growth rate, and if the activity of the nitrifying bacteria falls, then recovery requires considerable time. In order to stabilize the nitrification and preserve the treated water quality, identifying any nitrification anomalies and initiating rapid countermeasures is very important. Furthermore, in order to achieve stable biological treatment of a water to be treated containing dissolved ammonia nitrogen, although controlling the environmental conditions such as the water temperature and pH is important, maintaining the concentration of nutrients (such as phosphorus sources, trace metals and hydrogen donors) at or above a certain level in accordance with the ammonia nitrogen concentration in the water being treated is also important. Compared with public sewage that contains inflows from domestic wastewater, industrial wastewaters are more likely to have insufficient nutrients. In particular, in the case of ammonia nitrogen-containing wastewater discharged from chemical plants or semiconductor manufacturing plants, adequate nitrogen treatment can sometimes not be achieved unless nutrients are added. On the other hand, if nutrients are added at an excessive level, then water-quality and economic issues may arise, including leakage of the nutrients into the treated water and increased treatment costs.

Nitrification anomalies can be detected, for example, by conducting online measurements of the flow rate of the water to be treated, the ammonia nitrogen concentration in the water to be treated and the ammonia nitrogen concentration in the treated water, and monitoring the inflow ammonia load (kg-N/m³/day) and the ammonia removal rate. The flow rate of the water to be treated can be measured online simply using a flow rate sensor. The amounts added of nutrients such as phosphorus sources, trace metals and hydrogen donors can be optimized, for example, by conducting online measurements of the flow rate of the water to be treated and the concentration of ammonia nitrogen dissolved in the water to be treated. The flow rate of the water to be treated can be measured online simply using a flow rate sensor. On the other hand, examples of conventional methods that have been used for measuring the concentration of dissolved ammonia nitrogen include indophenol blue absorption spectrophotometry methods, neutralization titration methods, and ion chromatography methods. These methods require manual sampling and analysis, making continuous measurement of the ammonia nitrogen concentration impossible. For some online measurement methods, ammonia sensors that use a diaphragm electrode are being utilized. However, because the electrode section must be immersed in the solution, soiling adhered to the electrode section must be manually washed periodically. Online measurements are also possible with coulometric titration methods, but the SS component and the like within the water to be treated must be removed by a filtration treatment, and the filtration device requires manual replacement. Further, this method also suffers from high running costs for the electrolyte solution used in the measurements. Accordingly, a method for conducting online measurements of the dissolved ammonia nitrogen concentration that offers simple maintenance and low running costs would be very desirable.

Generally, non-contact liquid sensors are largely unaffected by soiling, and the costs associated with measurement are low. For example, Patent Document 1 has proposed a method for detecting the N₂ gas generated in the nitrification/denitrification step that can be used as a method for measuring the dissolved ammonia nitrogen concentration without any liquid contact. Further, in other examples, Patent Document 2, Patent Document 3, Patent Document 4, Patent Document 5, Patent Document 6 and Patent Document 7 propose methods in which a collected water sample is held under alkaline conditions, and the generated NH₃ gas is measured with an NH₃ gas sensor.

### CITATION LIST

### Patent Literature

Patent Document 1: JP H09-43226 A
Patent Document 2: JP S55-7667 A
Patent Document 3: JP S57-196147 A
Patent Document 4: JP S63-165751 A
Patent Document 5: JP H03-61856 A
Patent Document 6: JP H08-299988 A
Patent Document 7: JP 2022-37285 A

### SUMMARY

### Technical Problem

In order to enable stable biological treatment of a water to be treated containing dissolved ammonia nitrogen, operations must be conducted with the conditions for the biological treatment set appropriately in accordance with any fluctuations in the ammonia nitrogen concentration in the water being treated. However, because there are no simple conventional methods for measuring the concentration of dissolved ammonia nitrogen, rapidly ascertaining the concentration of ammonia nitrogen in the water being treated and then setting the biological treatment conditions appropriately is difficult. Further, as described above, in order to enable stable biological treatment of a water to be treated containing dissolved ammonia nitrogen, maintaining the concentration of nutrients at or above a certain level in accordance with the ammonia nitrogen concentration dissolved in the water being treated is also important. However, because there are no simple conventional methods for measuring the concentration of dissolved ammonia nitrogen, rapidly ascertaining the concentration of ammonia nitrogen in the water being treated and then supplying an appropriate amount of nutrients is difficult.

Accordingly, an object of the present invention is to provide a water treatment method and a water treatment apparatus which enable a water to be treated containing dissolved ammonia nitrogen to be subjected to a biological treatment in a stable manner, or to provide a water treatment method and a water treatment apparatus which, during the biological treatment of a water to be treated containing dissolved ammonia nitrogen, enable an appropriate amount of nutrients to be supplied.

### Solution to Problem

A water treatment method according to one embodiment of the present invention has a biological treatment step of biologically treating, in a biological treatment tank, a water to be treated containing dissolved ammonia nitrogen; a first measurement step of introducing a portion of the water to be treated flowing into the biological treatment tank into a first measurement tank as a first sample liquid, transferring the ammonia nitrogen dissolved in the first sample liquid, under alkaline conditions, into the gas phase of the first measurement tank as ammonia gas, and measuring the ammonia gas concentration C₁; a second measurement step of introducing a portion of the treated water that has undergone biological treatment in the biological treatment tank into a second measurement tank as a second sample liquid, transferring the ammonia nitrogen dissolved in the second sample liquid, under alkaline conditions, into the gas phase of the second measurement tank as ammonia gas, and measuring the ammonia gas concentration C₂; and a control step of controlling the operating conditions for the biological treatment step on the basis of the ammonia gas concentration C₁ and the ammonia gas concentration C₂.

Further, in the control step of the above water treatment method, the operating conditions for the biological treatment step are preferably controlled on the basis of the ammonia removal rate, which is determined by dividing the ammonia nitrogen concentration in the treated water, estimated from the ammonia gas concentration C₂, by the ammonia nitrogen concentration in the water to be treated, estimated from the ammonia gas concentration C₁.

Further, the above water treatment method preferably also has a flow rate measurement step of measuring the flow rate of the water to be treated flowing into the biological treatment tank, and the control step preferably controls the operating conditions for the biological treatment step on the basis of the ammonia removal rate and the inflow ammonia load, which is determined by multiplying the ammonia nitrogen concentration in the water to be treated by the flow rate of the water to be treated.

Furthermore, in the above water treatment method, it is preferable that the hydraulic retention time in the first measurement tank and the hydraulic retention time in the second measurement tank are each not more than ¼ of the hydraulic retention time in the biological treatment tank.

Further, in the above water treatment method, the operating conditions for the biological treatment step preferably include at least one of the flow rate of the water to be treated flowing into the biological treatment tank, the temperature inside the biological treatment tank, the pH inside the biological treatment tank, the inorganic carbon concentration in the biological treatment tank, and the sludge concentration in the biological treatment tank.

Moreover, a water treatment apparatus according to one embodiment of the present invention has a biological treatment tank for biologically treating a water to be treated containing dissolved ammonia nitrogen; a first measurement device which has a first measurement tank and introduces a portion of the water to be treated flowing into the biological treatment tank into the first measurement tank as a first sample liquid, transfers the ammonia nitrogen dissolved in the first sample liquid, under alkaline conditions, into the gas phase of the first measurement tank as ammonia gas, and measures the ammonia gas concentration C₁; a second measurement device which has a second measurement tank and introduces a portion of the treated water that has undergone biological treatment in the biological treatment tank into the second measurement tank as a second sample liquid, transfers the ammonia nitrogen dissolved in the second sample liquid, under alkaline conditions, into the gas phase of the second measurement tank as ammonia gas, and measures the ammonia gas concentration C₂; and a control device for controlling the operating conditions for the biological treatment in the biological treatment tank on the basis of the ammonia gas concentration C₁ and the ammonia gas concentration C₂.

Further, in the above water treatment apparatus, the control device preferably controls the operating conditions for the biological treatment in the biological treatment tank on the basis of the ammonia removal rate, which is determined by dividing the ammonia nitrogen concentration in the treated water, estimated from the ammonia gas concentration C₂, by the ammonia nitrogen concentration in the water to be treated, estimated from the ammonia gas concentration C₁.

Further, the above water treatment apparatus preferably also has a flow rate measurement device for measuring the flow rate of the water to be treated flowing into the biological treatment tank, and the control device preferably controls the operating conditions for the biological treatment in the biological treatment tank on the basis of the ammonia removal rate and the inflow ammonia load, which is determined by multiplying the ammonia nitrogen concentration in the water to be treated by the flow rate of the water to be treated.

Furthermore, in the above water treatment apparatus, it is preferable that the hydraulic retention time in the first measurement tank and the hydraulic retention time in the second measurement tank are each not more than ¼ of the hydraulic retention time in the biological treatment tank.

Further, in the above water treatment apparatus, the operating conditions for the biological treatment in the biological treatment tank preferably include at least one of the flow rate of the water to be treated flowing into the biological treatment tank, the temperature inside the biological treatment tank, the pH inside the biological treatment tank, the inorganic carbon concentration in the biological treatment tank, and the sludge concentration in the biological treatment tank.

A water treatment method according to one embodiment of the present invention has a biological treatment step of biologically treating, in a biological treatment tank, a water to be treated containing dissolved ammonia nitrogen; a nutrient supply step of supplying a nutrient to the biological treatment tank; a flow rate measurement step of measuring the flow rate of the water to be treated flowing into the biological treatment tank; a measurement step of introducing a portion of the water to be treated flowing into the biological treatment tank into a measurement tank as a sample liquid, transferring the ammonia nitrogen dissolved in the sample liquid, under alkaline conditions, into the gas phase of the measurement tank as ammonia gas, and measuring the ammonia gas concentration; and a control step of controlling the amount supplied of the nutrient on the basis of the ammonia nitrogen concentration in the water to be treated estimated from the ammonia gas concentration, and the flow rate of the water to be treated.

Further, in the above water treatment method, the hydraulic retention time in the measurement tank is preferably not more than ¼ of the hydraulic retention time in the biological treatment tank.

Further, in the above water treatment method, the nutrient preferably contains at least one of a phosphorus source, a trace metal and a hydrogen donor.

Furthermore, the above water treatment method preferably also has an acid agent supply step of supplying an acid agent to the measurement tank and washing the inside of the measurement tank.

Moreover, a water treatment apparatus according to one embodiment of the present invention has a biological treatment tank for biologically treating a water to be treated containing dissolved ammonia nitrogen; a nutrient supply device for supplying a nutrient to the biological treatment tank; a measurement device which has a measurement tank and introduces a portion of the water to be treated flowing into the biological treatment tank into the measurement tank as a sample liquid, transfers the ammonia nitrogen dissolved in the sample liquid, under alkaline conditions, into the gas phase of the measurement tank as ammonia gas, and measures the ammonia gas concentration; and a control device for controlling the amount supplied of the nutrient on the basis of the ammonia nitrogen concentration in the water to be treated estimated from the ammonia gas concentration, and the flow rate of the water to be treated.

Further, in the above water treatment apparatus, the hydraulic retention time in the measurement tank is preferably not more than ¼ of the hydraulic retention time in the biological treatment tank.

Further, in the above water treatment apparatus, the nutrient preferably contains at least one of a phosphorus source, a trace metal and a hydrogen donor.

Furthermore, the above water treatment apparatus preferably also has an acid agent supply device for supplying an acid agent to the measurement tank to wash the inside of the measurement tank.

### Advantageous Effects of Invention

By employing the present invention, a water treatment method and a water treatment apparatus can be provided which enable a water to be treated containing dissolved ammonia nitrogen to be subjected to a biological treatment in a stable manner, or alternatively, a water treatment method and a water treatment apparatus can be provided which, during the biological treatment of a water to be treated containing dissolved ammonia nitrogen, enable an appropriate amount of nutrients to be supplied.

### BRIEF DESCRIPTION OF DRAWINGS

FIG. 1 is a schematic structural diagram illustrating one example of a water treatment apparatus according to an embodiment of the present invention.

FIG. 2 is a schematic structural diagram illustrating one example of a first measurement device and a second measurement device.

FIG. 3 is a schematic structural diagram illustrating another example of the first measurement device and the second measurement device.

FIG. 4 is a graph illustrating the abundance ratios of NH₃ and NH₄⁺ at various pH values.

FIG. 5 is a schematic structural diagram illustrating another example of a water treatment apparatus according to an embodiment of the present invention.

FIG. 6 is a schematic structural diagram illustrating yet another example of a water treatment apparatus according to an embodiment of the present invention.

FIG. 7 is a diagram illustrating the relationship between the ammonia nitrogen concentration in a simulated wastewater and the ammonia gas concentration in the gas phase in Test Example 1.

FIG. 8 is a diagram illustrating the ammonia gas concentration in the gas phase for various calcium concentration levels (0 to 400 mg-Ca/L) in a simulated wastewater in Test Example 2.

FIG. 9 is a diagram illustrating the change over time in the ammonia gas concentration in the gas phase in Test Examples 3 and 4.

FIG. 10 is a diagram illustrating the measurement result for the ammonia gas concentration in the gas phase of a covered measurement tank in Test Example 1, and the measurement result for the ammonia gas concentration in the gas phase of an uncovered measurement tank of Test Example 9.

FIG. 11 is a schematic structural diagram illustrating one example of a water treatment apparatus according to an embodiment of the present invention.

FIG. 12 is a schematic structural diagram illustrating one example of a measurement device.

FIG. 13 is a schematic structural diagram illustrating another example of the first measurement device and the second measurement device.

FIG. 14 is a graph illustrating the abundance ratios of NH₃ and NH₄⁺ at various pH values.

FIG. 15 is a diagram illustrating the relationship between the ammonia nitrogen concentration in a simulated wastewater and the ammonia gas concentration in the gas phase in Test Example 11.

FIG. 16 is a diagram illustrating the ammonia gas concentration in the gas phase for various calcium concentration levels (0 to 400 mg-Ca/L) in a simulated wastewater in Test Example 12.

FIG. 17 is a diagram illustrating the change over time in the ammonia gas concentration in the gas phase in Test Examples 13 and 14.

FIG. 18 is a diagram illustrating the measurement result for the ammonia gas concentration in the gas phase of a covered measurement tank in Test Example 11, and the measurement result for the ammonia gas concentration in the gas phase of an uncovered measurement tank in Test Example 17.

### DESCRIPTION OF EMBODIMENTS

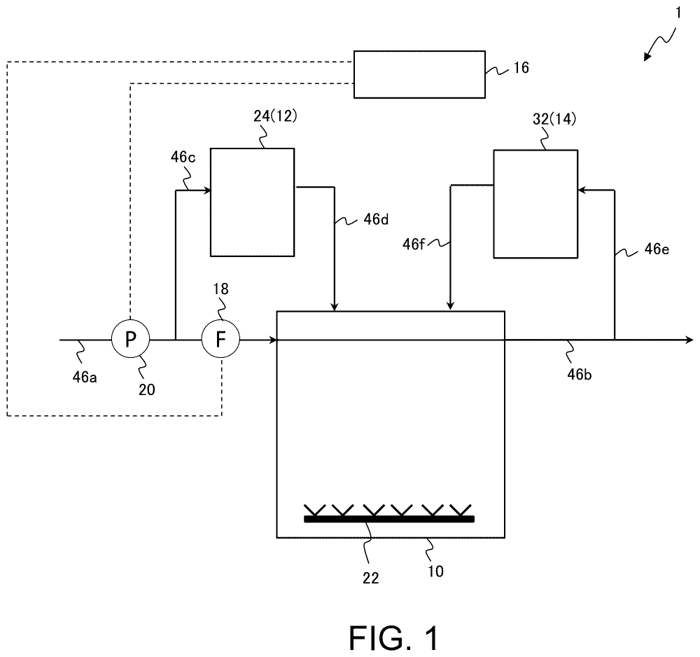

First, using FIG. 1 to FIG. 10, embodiments of a water treatment method and a water treatment apparatus are described that enable a water to be treated containing dissolved ammonia nitrogen to be subjected to a biological treatment in a stable manner. These embodiments are merely examples of implementing the present invention, and the present invention is not limited to these embodiments.

FIG. 1 is a schematic structural diagram illustrating one example of a water treatment apparatus according to an embodiment of the present invention. The water treatment apparatus 1 illustrated in FIG. 1 has a biological treatment tank 10, a first measurement device 12, a second measurement device 14, a control device 16, a flow rate meter 18, and a water to be treated supply pump 20. An aerator 22 is installed in the bottom of the biological treatment tank 10. For the first measurement device 12 and the second measurement device 14 illustrated in FIG. 1, only a first measurement tank 24 and a second measurement tank 32 respectively are drawn, with other components being omitted.

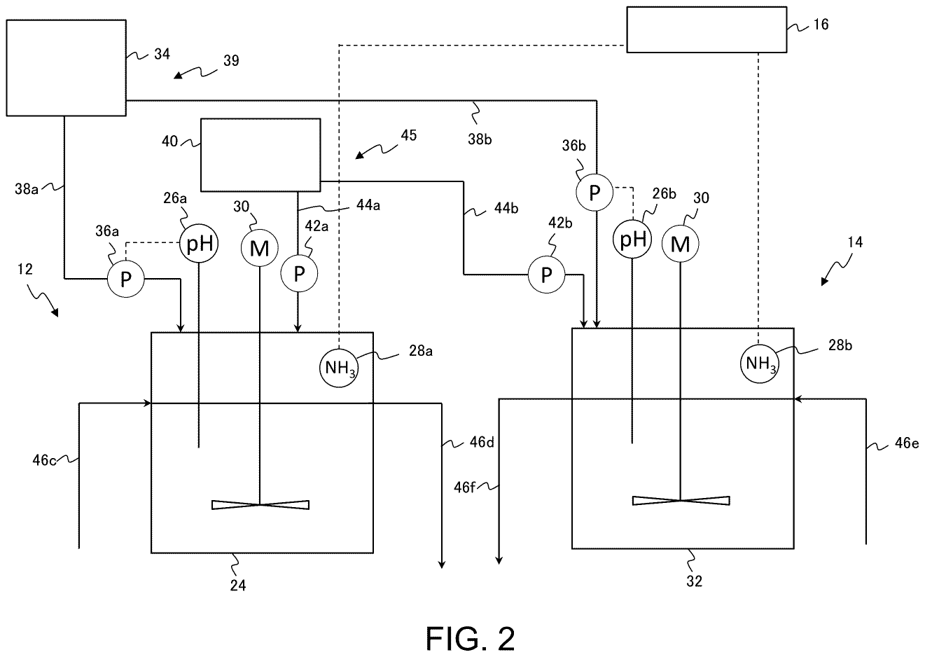

FIG. 2 is a schematic structural diagram illustrating one example of the first measurement device and the second measurement device. The first measurement device 12 has the first measurement tank 24, a pH meter 26a, an ammonia gas concentration meter 28a, and a stirrer 30. The ammonia gas concentration meter 28a is installed within the gas phase section of the first measurement tank 24. The second measurement device 14 has the second measurement tank 32, a pH meter 26b, an ammonia gas concentration meter 28b, and a stirrer 30. The ammonia gas concentration meter 28b is installed within the gas phase section of the second measurement tank 32. The ammonia gas concentration meters 28a and 28b may also be installed in lines connected to the gas phase section of the first measurement tank 24 and the gas phase section of the second measurement tank 32 respectively.

Further, the first measurement device 12 and the second measurement device 14 have a pH regulator supply device. This pH regulator supply device has, for example, an alkaline agent supply device 39 equipped with an alkaline agent storage tank 34, alkaline agent supply pumps 36a and 36b, and alkaline agent supply lines 38a and 38b, and an acid agent supply device 45 equipped with an acid agent storage tank 40, acid agent supply pumps 42a and 42b, and acid agent supply lines 44a and 44b. The pH meter 26a and the alkaline agent supply pump 36a, and the pH meter 26b and the alkaline agent supply pump 36b are electrically connected, either via wiring or wirelessly. The alkaline agent supply pumps 36a and 36b may be operated, for example, by reading the pH values from the pH meters 26a and 26b, and then ensuring that the insides of the first measurement tank 24 and the second measurement tank 32 are maintained under alkaline conditions. In this embodiment, a single pH regulator supply device is used for both the first measurement device 12 and the second measurement device 14, but a separate pH regulator supply device may be supplied for each of the first measurement device 12 and the second measurement device 14.

A line 46a is connected to the biological treatment tank 10. The flow rate meter 18 and the water to be treated supply pump 20 are installed in this line 46a. Further, a line 46b is also connected to the biological treatment tank 10. One end of a line 46c is connected to the line 46a, and the other end of the line 46c is connected to the first measurement tank 24. Further, one end of a line 46d is also connected to the first measurement tank 24, and the other end of the line 46d is connected to the biological treatment tank 10. One end of a line 46e is connected to the line 46b, and the other end of the line 46e is connected to the second measurement tank 32. Further, one end of a line 46f is also connected to the second measurement tank 32, and the other end of the line 46f is connected to the biological treatment tank 10. One end of the alkaline agent supply line 38a is connected to the alkaline agent storage tank 34, and the other end of the alkaline agent supply line 38a is connected to the first measurement tank 24. Further, one end of the alkaline agent supply line 38b is also connected to the alkaline agent storage tank 34, and the other end of the alkaline agent supply line 38b is connected to the second measurement tank 32. The alkaline agent supply pump 36a is installed in the alkaline agent supply line 38a, and the alkaline agent supply pump 36b is installed in the alkaline agent supply line 38b. One end of the acid agent supply line 44a is connected to the acid agent storage tank 40, and the other end of the acid agent supply line 44a is connected to the first measurement tank 24. Further, one end of the acid agent supply line 44b is also connected to the acid agent storage tank 40, and the other end of the acid agent supply line 44b is connected to the second measurement tank 32. The acid agent supply pump 42a is installed in the acid agent supply line 44a, and the acid agent supply pump 42b is installed in the acid agent supply line 44b.

The control device 16 is electrically connected, either by wiring or wirelessly, to the ammonia gas concentration meters 28a and 28b, the flow rate meter 18, and the water to be treated supply pump 20. The control device 16 is, for example, composed of a microcomputer comprising a CPU that executes programs and ROM and RAM that store programs and operational results, and electrical circuits and the like, and the control device 16 reads a prescribed program stored in ROM or the like, and executes that program to control the operation of the water treatment apparatus 1. Although described in more detail below, for example, the control device 16 may control the operation of the water to be treated supply pump 20 on the basis of the ammonia gas concentrations measured by the ammonia gas concentration meters 28a and 28b.

A description of one example of the operation of the water treatment apparatus 1 according to this embodiment is described below.

The water to be treated supply pump 20 is activated, causing the water to be treated containing dissolved ammonia nitrogen to flow from the line 46a into the biological treatment tank 10. Inside the biological treatment tank 10, an oxygen-containing gas such as air is supplied by the aerator 22, thereby mixing the water to be treated and the sludge containing the microbes. In the biological treatment tank 10, the ammonia nitrogen in the water to be treated is subjected to a biological treatment (for example, a nitrification treatment) under aerobic conditions by the microbes. The biological treatment step that occurs in the biological treatment tank 10 is not limited to only a nitrification treatment, and may be any biological treatment that includes a nitrification treatment. The treated water that has been treated in the biological treatment tank 10 is discharged through the line 46b.

Further, in this embodiment, a portion of the wastewater passing through the line 46a is introduced into the first measurement tank 24 from the line 46c as a first sample liquid, and a portion of the treated water passing through the line 46b is introduced into the second measurement tank 32 from the line 46e as a second sample liquid. The pH levels of the first sample liquid and the second sample liquid are measured as required by the pH meters 26a and 26b respectively, and the alkaline agent supply pumps 36a and 36b are operated on the basis of the measured pH values. By activating the alkaline agent supply pumps 36a and 36b, a prescribed amount of the alkaline agent is supplied from the alkaline agent storage tank 34 to the first measurement tank 24 and the second measurement tank 32 respectively, enabling the insides of the first measurement tank 24 and second measurement tank 32 to be maintained under alkaline conditions. In the first measurement tank 24, the first sample liquid and the alkaline agent are stirred by the stirrer 30, and in the second measurement tank 32, the second sample liquid and the alkaline agent are stirred by the stirrer 30.

In the first measurement tank 24, alkaline conditions are established, the ammonia nitrogen dissolved in the first sample liquid migrates into the gas phase as ammonia gas (NH₃), and the ammonia gas concentration C₁ is measured by the ammonia gas concentration meter 28a (the first measurement step). Further, in the second measurement tank 32, in a similar manner, alkaline conditions are established, a portion of the ammonia nitrogen dissolved in the second sample liquid migrates into the gas phase as ammonia gas (NH₃), and the ammonia gas concentration C₂ is measured by the ammonia gas concentration meter 28b (the second measurement step).

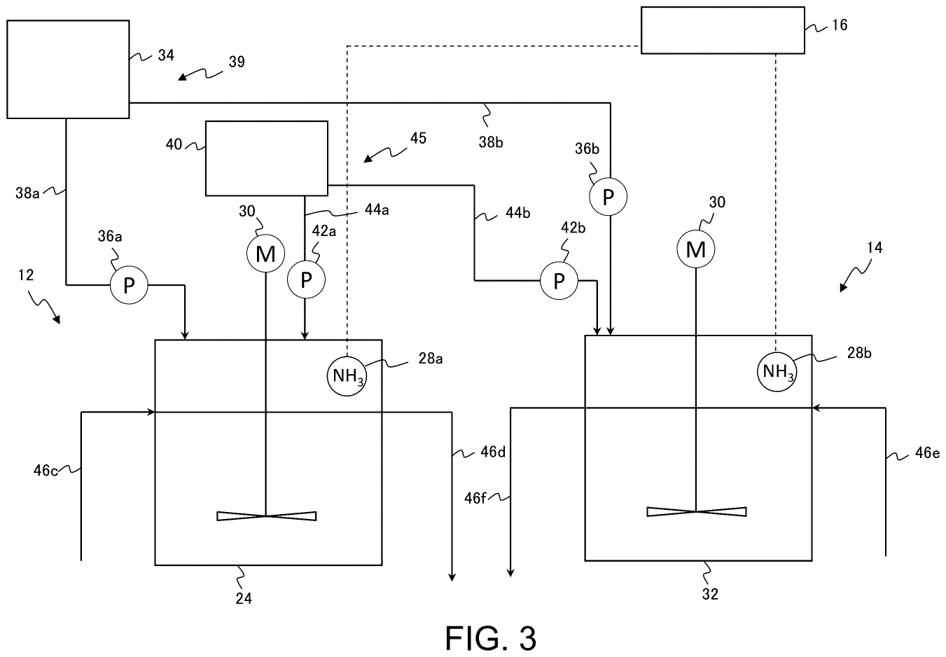

FIG. 3 is a schematic structural diagram illustrating another example of the first measurement device and the second measurement device. The first measurement device 12 and the second measurement device 14 illustrated in FIG. 3 are not equipped with pH meters. In the first measurement device 12 and the second measurement device 14, the alkaline agent is added in a fixed ratio relative to the water inflow rate, thereby ensuring alkaline conditions inside the tanks, and the ammonia gas concentration C₁ and the ammonia gas concentration C₂ are then measured.

The ammonia nitrogen in the sample liquids exists as NH₃ and NH₄⁺, and the equilibrium relationship is represented by the formula shown below.

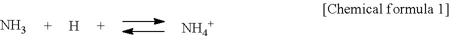

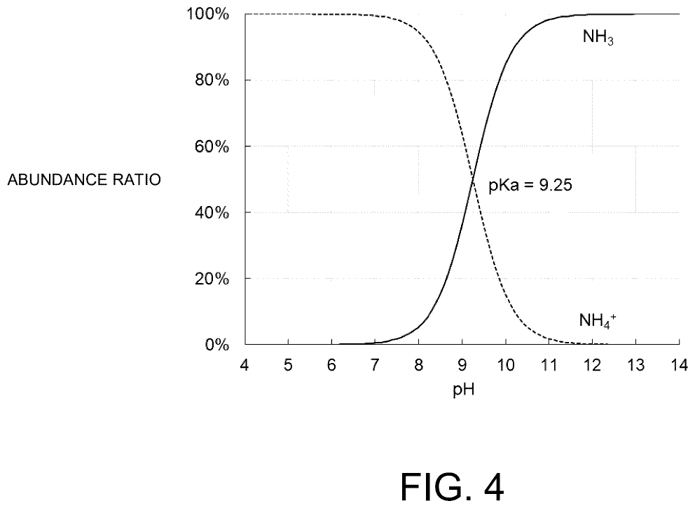

FIG. 4 illustrates the abundance ratios of NH₃ and NH₄⁺ at various pH values. The acid dissociation constant (pKa) for NH₄⁺ is 9.25, and the abundance ratio of NH₃ in the dissolved ammonia nitrogen is 8% at pH 8, 36% at pH 9, 85% at pH 10, and 98% at pH 11. A portion of the dissolved NH₃ volatilizes as ammonia gas (NH₃ gas). If the abundance ratio of NH₃ is high, then the amount of NH₃ that volatilizes as NH₃ gas also increases. The insides of the measurement tanks may be set at any level of alkalinity, but in terms of enabling the ammonia gas to be measured easily with the ammonia gas concentration meters even when the concentration of dissolved ammonia nitrogen is low, the pH inside the measurement tanks is preferably at least 10, and more preferably 11 or higher.

The control device 16 controls the operation of the biological treatment in the biological treatment tank 10 on the basis of the ammonia gas concentrations C₁ and C₂ (the control step). In relation to the ammonia gas concentrations C₁ and C₂ measured by the ammonia gas concentration meters 28a and 28b, for example, if the ammonia gas concentration C₂ is low compared with the ammonia gas concentration C₁, then it can be stated that the ammonia nitrogen in the treated water is being satisfactorily removed, and the biological treatment can be assumed to be proceeding normally, whereas if there is almost no difference between the two concentration levels, then it can be surmised that the biological treatment is not proceeding satisfactorily, and a problem exists. For example, in those cases where the difference between the ammonia gas concentrations C₁ and C₂ is equal to or less than a prescribed value (or the ratio of C₂/C₁ is equal to or greater than a prescribed value), the control device 16 infers that the biological treatment is abnormal, and therefore lowers the output of the water to be treated supply pump 20 and reduces the flow rate of the water to be treated supplied to the biological treatment tank 10. As a result, the inflow ammonia load on the biological treatment tank 10 is reduced, thereby improving the ammonia nitrogen treatment capacity. Subsequently, when the difference between the ammonia gas concentrations C₁ and C₂ exceeds the prescribed value (or when the ratio of C₂/C₁ is less than the prescribed value), the control device 16 infers that the biological treatment is proceeding normally, and therefore raises the output of the water to be treated supply pump 20 and returns the flow rate of the water to be treated to normal. This flow control of the water to be treated is not limited to the case where the water to be treated supply pump 20 is controlled, and may also be achieved, for example, by adjusting the degree of opening of a valve installed in the line 46a.

Items that may be controlled within the operating conditions for the biological treatment reaction are not limited to the flow rate of the water to be treated flowing into the biological treatment tank 10, and examples of other control items include the temperature inside the biological treatment tank 10, the pH inside the biological treatment tank 10, the inorganic carbon concentration in the biological treatment tank 10, and the sludge concentration in the biological treatment tank 10. For example, in the case where, as described above, the control device 16 infers that the biological treatment is abnormal based on the ammonia gas concentrations C₁ and C₂, the control device 16 may activate a device (not shown in the drawings) for supplying steam into the biological treatment tank 10, thereby supplying steam into the biological treatment tank 10, raising the temperature inside the biological treatment tank 10, and improving the ammonia nitrogen treatment capacity. Further, in the case where, as described above, the control device 16 infers that the biological treatment is abnormal based on the ammonia gas concentrations C₁ and C₂, the control device 16 may activate a device (not shown in the drawings) for supplying a pH regulator into the biological treatment tank 10, thereby adjusting the pH inside the biological treatment tank 10 (for example, to a value within a range from pH 7.5 to 8.0), raising the inorganic carbon concentration inside the tank, and improving the ammonia nitrogen treatment capacity. Furthermore, in the case where, as described above, the control device 16 infers that the biological treatment is abnormal based on the ammonia gas concentrations C₁ and C₂, the control device 16 may activate a device (not shown in the drawings) for supplying a bicarbonate salt or a carbonate salt into the biological treatment tank 10, thereby raising the inorganic carbon concentration inside the biological treatment tank 10, and improving the ammonia nitrogen treatment capacity. Furthermore, in the case where, as described above, the control device 16 infers that the biological treatment is abnormal based on the ammonia gas concentrations C₁ and C₂, the control device 16 may activate a device (not shown in the drawings) for supplying a biological sludge to the biological treatment tank 10, thereby increasing the amount of biological sludge inside the biological treatment tank 10, and improving the ammonia nitrogen treatment capacity. Moreover, subsequently, when the control device 16 infers, based on the ammonia gas concentrations C₁ and C₂, that the biological treatment reaction is once again proceeding normally, the operating conditions for the biological treatment are returned to their original states. The operating condition controls described above are merely examples, and the operating conditions may also be controlled, for example, in accordance with the difference or the ratio between the ammonia gas concentrations C₁ and C₂.

In this manner, by controlling the operating conditions for the biological treatment of the water to be treated containing dissolved ammonia nitrogen on the basis of the ammonia gas concentration detected on the side of the water to be treated and the ammonia gas concentration detected on the side of the treated water that has undergone the biological treatment, appropriate conditions for the biological treatment can be set even if, for example, the ammonia nitrogen concentration in the water to be treated fluctuates, and therefore the water to be treated containing dissolved ammonia nitrogen can be biologically treated in a stable manner. In this embodiment, because non-contact ammonia gas concentration meters are used for the treated water and the water to be treated containing dissolved ammonia nitrogen, there is no need to clean soiling or scale from the sensor portions of the concentration meters, making maintenance simple.

The control device 16 may also control the operating conditions for the biological treatment on the basis of the ammonia removal rate, which is determined by dividing the ammonia nitrogen concentration D₂ in the treated water, estimated from the ammonia gas concentration C₂, by the ammonia nitrogen concentration D₁ in the water to be treated, estimated from the ammonia gas concentration C₁. One example of this control method is described below. Information on the correlation between the dissolved ammonia nitrogen concentration and the ammonia gas concentration is first stored in the control device 16 in advance. Then, using that correlation information, the control device 16 determines the dissolved ammonia nitrogen concentration (this refers to the ammonia nitrogen concentration D₁ in the water to be treated) from the ammonia gas concentration C₁ detected by the ammonia gas concentration meter 28a. Further, using the correlation information, the control device 16 also determines the dissolved ammonia nitrogen concentration (this refers to the ammonia nitrogen concentration D₂ in the treated water) from the ammonia gas concentration C₂ detected by the ammonia gas concentration meter 28b. The control device 16 then divides the ammonia nitrogen concentration D₂ in the treated water by the ammonia nitrogen concentration D₁ in the water to be treated (D₂/D₁), and uses this value to determine the ammonia removal rate (1-D₂/D₁). In those cases where the ammonia removal rate differs from the preset planned value, the control device 16 adjusts the operating conditions for the biological treatment, for example, in the same manner as that described above for the case where the biological treatment is deemed to be abnormal. Subsequently, when the ammonia removal rate moves back within the preset planned value range, the control device 16 returns the operating conditions for the biological treatment to their original states. The control device 16 may also control the operating conditions for the biological treatment in accordance with increases and decreases in the ammonia removal rate.

The control device 16 may also control the operating conditions for the biological treatment on the basis of the ammonia removal rate and the inflow ammonia load, which is determined by multiplying the ammonia nitrogen concentration D₁ in the water to be treated by the flow rate of the water to be treated flowing into the biological treatment tank 10. One example of this control method is described below. The control device 16 calculates the ammonia removal rate from the ammonia nitrogen concentration D₁ in the water to be treated and the ammonia nitrogen concentration D₂ in the treated water in the manner described above. Further, the control device 16 also calculates the inflow ammonia load by multiplying the water to be treated flow rate detected by the flow rate meter 18 by the ammonia nitrogen concentration D₁ in the water to be treated. In those cases where the ammonia removal rate and the inflow ammonia load differ from the respective preset planned values, the control device 16 adjusts the operating conditions for the biological treatment, for example, in the same manner as that described above for the case where the biological treatment is deemed to be abnormal. Subsequently, when the ammonia removal rate and the inflow ammonia load move back within their respective preset planned value ranges, the control device 16 returns the operating conditions for the biological treatment to their original states. The control device 16 may also control the operating conditions for the biological treatment in accordance with increases and decreases in the ammonia removal rate and increase and decrease in the inflow ammonia load.

The planned value for the ammonia removal rate is, for example, preferably a range from 90% to 100%, and more preferably a range from 95% to 100%. The planned value for the inflow ammonia load is, for example, preferably a range from 0.1 to 0.3 kg-N/m³/day in the case of an activated sludge method, and is, for example, preferably a range from 0.5 to 1.0 kg-N/m³/day in the case of a biofilm method (for example, a fixed bed system or moving bed system) or a granular method.

Next are detailed descriptions of the biological treatment tank 10, the first measurement device 12 and the second measurement device 14. In the following description, when the expression “measurement device” is used, this refers to at least one of the first measurement device 12 and the second measurement device 14, whereas the expression “measurement tank” refers to at least one of the first measurement tank 24 and the second measurement tank 32.

The biological treatment tank 10 may adopt any configuration, provided it is capable of biologically treating the water to be treated containing dissolved ammonia nitrogen. Examples include biological treatment tanks or the like that conduct biological treatment of a water to be treated containing dissolved ammonia nitrogen using an activated sludge method, a membrane bioreactor method (MBR), a fixed bed or moving bed biofilm method, or a granular method. Further, examples of the biological treatment of the water to be treated containing dissolved ammonia nitrogen include nitrification methods, nitrification/denitrification methods, circulating nitrification/denitrification methods, and anaerobic ammonia oxidation methods (for example, the anammox method). The biological treatment tank 10 is not limited to a single tank, and as described below, may also be composed of a plurality of tanks.

The measurement tank that constitutes part of the measurement device preferably has a closed cover. By covering the measurement tank, dilution of the ammonia gas concentration due to ingress of air is suppressed, meaning the ammonia gas detection sensitivity of the ammonia gas concentration meter can be improved.

A heater is preferably installed in the measurement tank to heat the inside of the measurement tank. This enables the ammonia gas concentration in the gas phase inside the measurement tank to be increased. Further, the gas phase inside the measurement tank may also be circulated using a blower. In such cases, the measurement tank is preferably totally sealed. In order to prevent ingress of air into the measurement tank, the line 46d connected to the first measurement tank 24 and the line 46f connected to the second measurement tank 32 are preferably water sealed. For example, these lines may be water sealed by providing a water tank filled with water in the line 46d and the line 46f, by extending the line 46d and the line 46f to positions lower than the water level in the biological treatment tank 10, or by forming the line 46d and the line 46f with S-bends.

The inflow of the first sample liquid into the first measurement tank 24 and the inflow of the second sample liquid into the second measurement tank 32 may each be continuous or intermittent.

The hydraulic retention time in the first measurement tank 24 and the hydraulic retention time in the second measurement tank 32 are each preferably not more than ¼ of the hydraulic retention time in the biological treatment tank 10. By ensuring that the hydraulic retention time in the measurement tank is not more than ¼ of the hydraulic retention time in the biological treatment tank 10, for example, any anomalies in the biological treatment in the biological treatment tank 10 can be detected more rapidly.

In order to avoid condensation on the ammonia gas concentration meters 28a and 28b, a mist separator may be installed in front of the ammonia gas concentration meters 28a and 28b. Examples of the ammonia gas concentration meters 28a and 28b include electrochemical, semiconductor-based and contact combustion-type ammonia gas concentration meters. Measurement of the ammonia gas concentration may be conducted online or manually.

The first sample liquid discharged from the first measurement tank 24 and the second sample liquid discharged from the second measurement tank 32 are preferably returned to the biological treatment tank 10 under alkaline conditions. In the biological treatment tank 10, alkali is consumed, for example, in accordance with the above formula 1. Accordingly, by returning the first sample liquid discharged from the first measurement tank 24 and the second sample liquid discharged from the second measurement tank 32 to the biological treatment tank 10 via the line 46d and the line 46f respectively, the biological treatment tank 10 can be replenished with alkali. Examples of the alkaline agent supplied to the measurement tank for ammonia gas measurement include sodium hydroxide, potassium hydroxide and calcium hydroxide.

Scale may sometimes be deposited inside the first measurement tank 24 and the second measurement tank 32, and therefore the insides of these tanks are preferably washed periodically. For example, the acid agent supply pumps 42a and 42b may be activated periodically (for example, once per day), thereby supplying prescribed amounts of an acid agent from the acid agent storage tank 40 to the first measurement tank 24 and the second measurement tank 32 to remove the scale and wash the inside of the tanks.

The wastewater produced following supply of the acid agent to the measurement tank to wash the inside of the tank is, for example, preferably supplied to the denitrification tank. As shown in formula 2 above, alkali is produced in the denitrification tank, and therefore by supplying the wastewater produced following scale removal from inside the measurement tank to the denitrification tank, the denitrification tank can be replenished with acid. Examples of the acid supplied to the measurement tank for washing the inside of the tank include hydrochloric acid, sulfuric acid, nitric acid, phosphoric acid, citric acid, oxalic acid, lactic acid, ascorbic acid and malic acid. Among these, hydrochloric acid or nitric acid is preferred, as each enables a large reduction in the pH with a small amount of added acid.

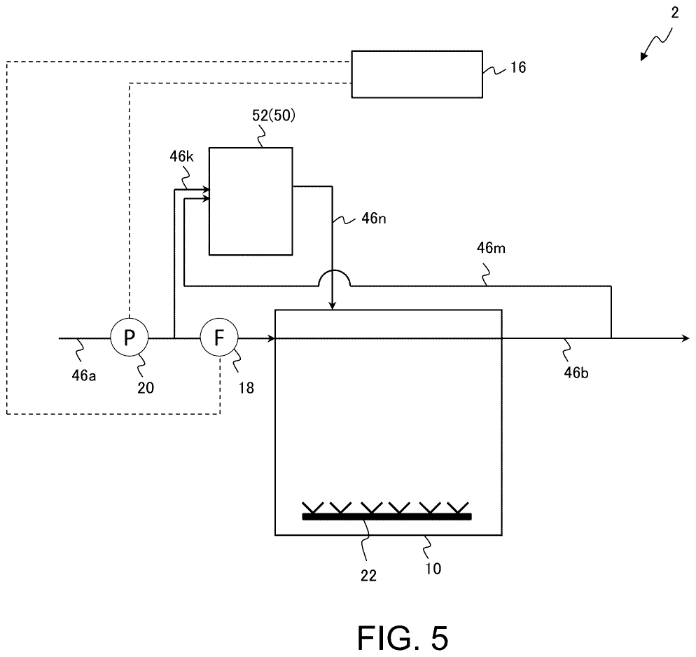

FIG. 5 is a schematic structural diagram illustrating another example of a water treatment apparatus according to an embodiment of the present invention. In the water treatment apparatus 2 illustrated in FIG. 5, structures that are the same as those of the water treatment apparatus 1 illustrated in FIG. 1 are labeled with the same reference signs. In the water treatment apparatus 2 illustrated in FIG. 5, a single measurement device 50 is provided which combines the functions of the first measurement device and the second measurement device described above. The single measurement device 50 has a single measurement tank 52 which combines the functions of the first measurement tank and the second measurement tank. In FIG. 5, the single measurement device 50 is drawn showing only the single measurement tank 52, with other components being omitted, but in a similar manner to that described above for the first measurement device and the second measurement device, the single measurement device 50 may also include, for example, a pH meter, an ammonia gas concentration meter, a stirrer, an alkaline agent supply device, and an acid agent supply device and the like.

As illustrated in FIG. 5, one end of a line 46k is connected to the line 46a, and the other end of the line 46k is connected to the single measurement tank 52. One end of a line 46m is connected to the line 46b, and the other end of the line 46m is connected to the single measurement tank 52. One end of a line 46n is connected to the single measurement tank 52, and the other end of the line 46n is connected to the biological treatment tank 10.

In the water treatment apparatus 2 illustrated in FIG. 5, the ammonia gas concentration is measured, for example, in the manner described below. First, a portion of the water to be treated flowing through the line 46a is introduced from the line 46k into the single measurement tank 52 as a first sample liquid. The pH of the first sample liquid is then measured as required with a pH meter, and based on the measured pH value, a prescribed amount of an alkaline agent is supplied from an alkaline agent supply device to the single measurement tank 52, enabling the inside of the tank to be maintained under alkaline conditions. In the single measurement tank 52, alkaline conditions are established, a portion of the ammonia nitrogen dissolved in the first sample liquid migrates into the gas phase as ammonia gas, and the ammonia gas concentration C₁ is measured using an ammonia gas concentration meter. After a prescribed period of time has passed, supply of the first sample liquid to the single measurement tank 52 is halted, and measurement of the ammonia gas concentration C₁ is completed. Next, a portion of the treated water flowing through the line 46b is introduced from the line 46m into the single measurement tank 52 as a second sample liquid, thus replacing the first sample liquid inside the single measurement tank 52 with the second sample liquid. Once the first sample liquid inside the tank has been replaced with the second sample liquid, the same procedure as described above is used to establish alkaline conditions inside the tank, transfer a portion of the ammonia nitrogen dissolved in the second sample liquid into the gas phase as ammonia gas, and then measure the ammonia gas concentration C₂ using the ammonia gas concentration meter. In this manner, by using the water treatment apparatus 2 illustrated in FIG. 5, measurements of the ammonia gas concentrations C₁ and C₂ inside the single measurement tank 52 are repeated alternately at a prescribed time interval.

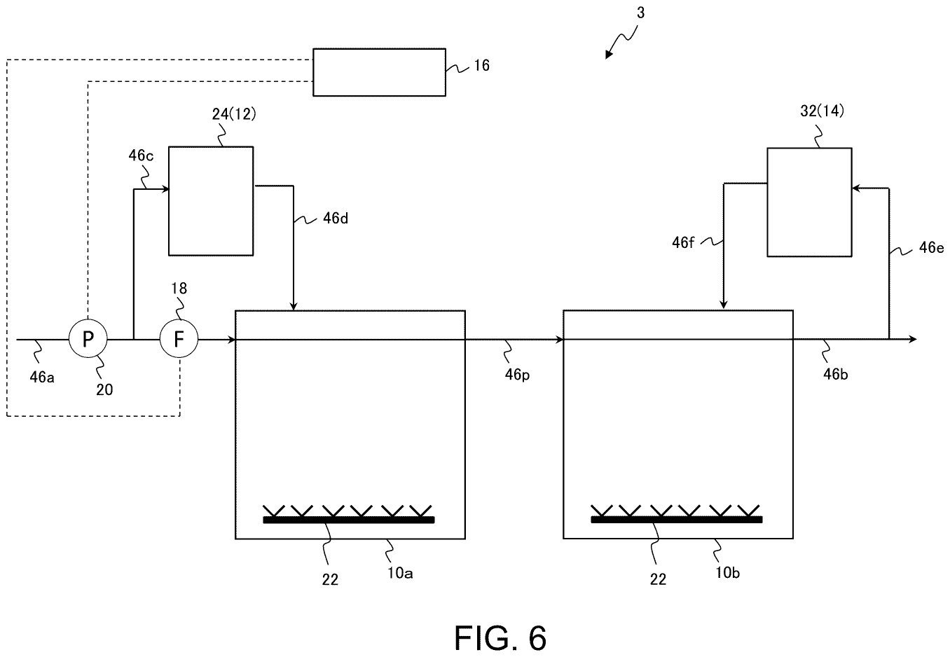

FIG. 6 is a schematic structural diagram illustrating yet another example of the water treatment apparatus according to an embodiment of the present invention. In the water treatment apparatus 3 illustrated in FIG. 6, structures that are the same as those of the water treatment apparatus 1 illustrated in FIG. 1 are labeled with the same reference signs. The water treatment apparatus 3 illustrated in FIG. 6 has a plurality of biological treatment tanks. As illustrated in FIG. 6, a biological treatment tank 10a and a biological treatment tank 10b are connected by a line 46p. In the water treatment apparatus 3 illustrated in FIG. 6, a portion of the water to be treated flowing into the most upstream stage biological treatment tank 10a is introduced into the first measurement tank 24 as the first sample liquid, and the ammonia gas concentration C₁ is measured. Further, a portion of the treated water discharged from the most downstream biological treatment tank 10b is introduced into the second measurement tank 32 as the second sample liquid, and the ammonia gas concentration C₂ is measured.

### Test Example 1

A simulated wastewater containing ammonia nitrogen (1 to 50 mg-N/L), calcium (400 mg-Ca/L), inorganic carbon (20 mg-C/L), phosphorus (1 mg-P/L) and trace metals was flowed through a covered measurement tank having a liquid phase volume of 1 L and a gas phase volume of 0.4 L with a hydraulic retention time (HRT) of 10 minutes. A 25% sodium hydroxide solution was added to the tank in an amount sufficient to adjust the pH inside the measurement tank to 11 or higher, and the solution in the tank was thoroughly mixed with a stirrer. The water temperature was set to a value of 20 to 23° C., and under normal atmospheric pressure, 30 minutes after the introduction of the simulated wastewater into the tank, the ammonia gas concentration that had migrated into the gas phase of the measurement tank was measured using an ammonia gas sensor. Further, the ammonia nitrogen concentration in the simulated wastewater was measured using the indophenol blue absorption spectrophotometry method.

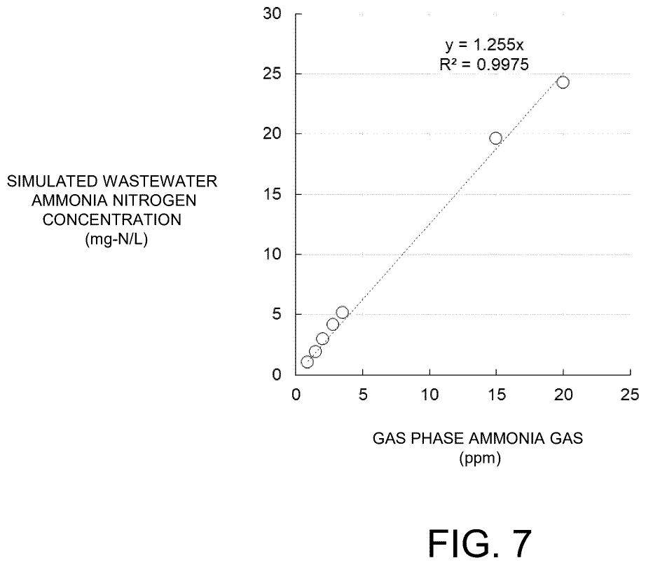

FIG. 7 illustrates the relationship between the ammonia nitrogen concentration in the simulated wastewater and the ammonia gas concentration in the gas phase in Test Example 1. As illustrated in FIG. 7, the ammonia nitrogen concentration in the simulated wastewater and the ammonia gas concentration in the gas phase exhibit a positive correlation (coefficient of determination R²=0.9956). Accordingly, it was evident that by using an approximation expression, the ammonia nitrogen concentration in the simulated wastewater could be calculated from the ammonia gas concentration in the gas phase.

### Test Example 2

A simulated wastewater containing an ammonia nitrogen concentration of 20 mg-N/L and a calcium concentration of 0 to 400 mg-Ca/L was flowed through the measurement tank. Other conditions were set as described in Test Example 1.

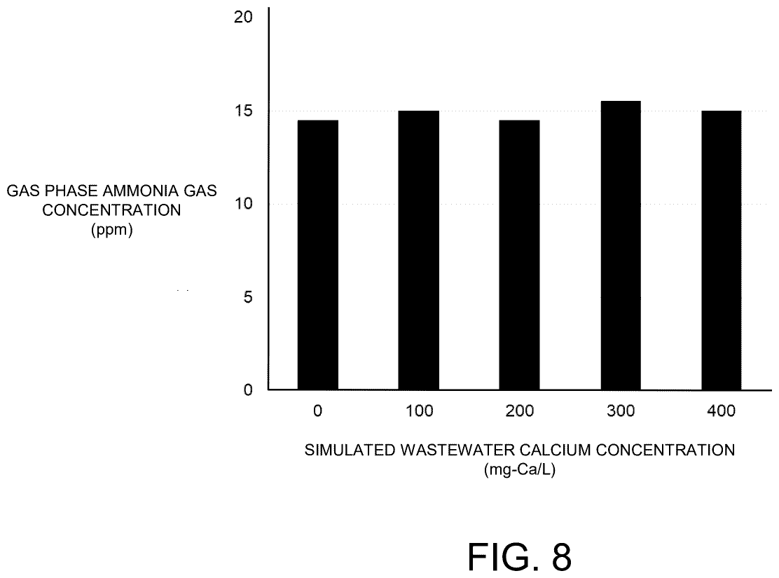

FIG. 8 illustrates the ammonia gas concentration in the gas phase for various calcium concentrations (0 to 400 mg-Ca/L) in the simulated wastewater of Test Example 2. As illustrated in FIG. 8, even when the calcium concentration in the simulated wastewater changes, there is almost no effect on the ammonia gas concentration in the gas phase. In this manner, because the ammonia gas concentration in the gas phase is independent of the calcium concentration in the simulated wastewater, there is no need to conduct a pretreatment to remove the calcium from the wastewater when measuring the ammonia gas concentration.

### Test Example 3

A simulated wastewater containing an ammonia nitrogen concentration of 20 mg-N/L was flowed through the measurement tank with an HRT of 10 minutes. At 0 minutes, 5 minutes, 10 minutes, 15 minutes, 30 minutes, 45 minutes, and 60 minutes after the start of the inflow, the ammonia gas concentration in the gas phase was measured. Other conditions were set as described in Test Example 1.

### Test Example 4

A simulated wastewater containing an ammonia nitrogen concentration of 20 mg-N/L was flowed through the measurement tank with an HRT of 5 minutes. At 0 minutes, 2.5 minutes, 5 minutes, 10 minutes, 15 minutes, 20 minutes, and 30 minutes after the start of the inflow, the ammonia gas concentration in the gas phase was measured. Other conditions were set as described in Test Example 1.

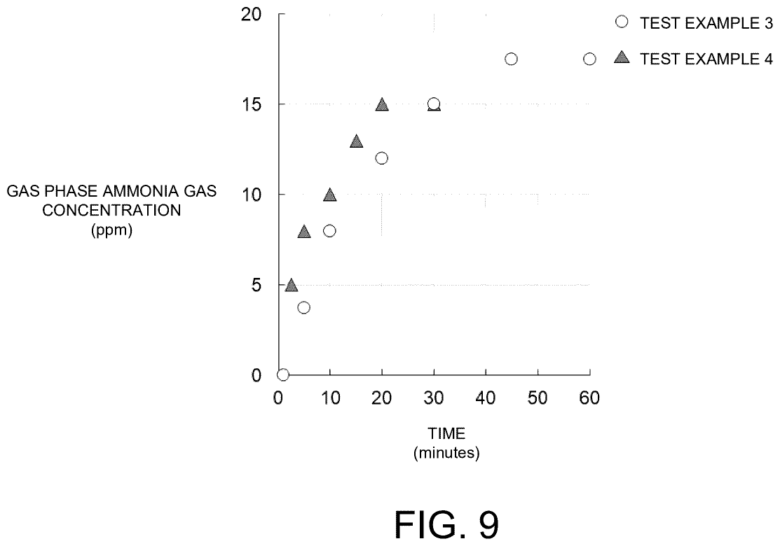

FIG. 9 illustrates the change over time in the ammonia gas concentration in the gas phase in Test Examples 3 and 4. As illustrated in FIG. 9, in order for the ammonia gas concentration in the gas phase to reach a maximum value, a time that was 4 times the measurement tank HRT was required. Because it is preferable that the NH₃ gas concentration reaches a maximum value at least once within 1 HRT for the biological treatment tank, the HRT for the measurement tank is preferably set to not more than ¼ of the HRT for the biological treatment tank. The measurement tank HRT can be increased or decreased by controlling the inflow rate of the simulated wastewater into the measurement tank. Provided the measurement tank is sufficiently small compared with the biological treatment tank, the inflow rate of the simulated wastewater may be low, and the pump used for supplying the simulated wastewater to the measurement tank can be reduced in size.

### Test Example 5

A semiconductor plant wastewater containing ammonia nitrogen was introduced into the measurement tank. Other conditions were set as described in Test Example 1. Based on the actual measured value for the ammonia nitrogen concentration in the semiconductor plant wastewater measured using the indophenol blue absorption spectrophotometry method, and the measured value for the ammonia gas concentration in the gas phase, a correlation was confirmed using this wastewater in the same manner as described in Test Example 1, and the relative error in the value for the ammonia nitrogen concentration calculated using the obtained approximation expression was 13%. These results confirmed that the ammonia gas concentration in the gas phase, measured without first filtering the wastewater, could be used to calculate the ammonia nitrogen concentration in a semiconductor plant wastewater.

### Test Example 6

The simulated wastewater used in Test Example 1 was supplied to a nitrification tank packed with a sponge-like carrier, and a biological treatment was conducted. The treated water discharged from the nitrification tank was introduced into a measurement tank. Other conditions were set as described in Test Example 1.

The amount of suspended solids (SS) in the treated water was 18 mg/L, and the ammonia nitrogen concentration measured using the indophenol blue absorption spectrophotometry method was 17.9 mg-N/L. The ammonia gas concentration in the gas phase of the measurement tank was 14.5 ppm, and calculation of the ammonia nitrogen concentration in the wastewater using the approximation expression determined in Test Example 1 yielded a result of 18.2 mg-N/L. The relative error between the actual measured value obtained using the indophenol blue absorption spectrophotometry method and the value calculated from the ammonia gas concentration in the gas phase was 1.6%.

### Test Example 7

A nitrification tank for conducting a biological treatment using a semi-batch activated sludge nitrogen removal method was supplied with the simulated wastewater used in Test Example 1, and a biological treatment was conducted. The treated water discharged from the nitrification tank was introduced into a measurement tank. Other conditions were set as described in Test Example 1.

The amount of SS in the treated water was 1,700 mg/L, and the ammonia nitrogen concentration measured using the indophenol blue absorption spectrophotometry method was 12.9 mg-N/L. The ammonia gas concentration in the gas phase of the measurement tank was 9.5 ppm, and calculation of the ammonia nitrogen concentration in the wastewater using the approximation expression determined in Test Example 1 yielded a result of 11.9 mg-N/L. The relative error between the actual measured value obtained using the indophenol blue absorption spectrophotometry method and the value calculated from the ammonia gas concentration in the gas phase was 7.6%. These results confirmed that the ammonia gas concentration in the gas phase, measured without first filtering the treated water, could be used to calculate the ammonia nitrogen concentration in a treated water.

### Test Example 8

A 20% hydrochloric acid solution was added to the measurement tank used in Test Example 1, thereby reducing the pH inside the tank to 2 or lower, and the solution inside the tank was stirred for 5 minutes. As a result, scale that had been deposited inside the tank under the alkaline conditions was dissolved.

### Test Example 9

A simulated wastewater containing an ammonia nitrogen concentration of 20 mg-N/L was flowed through an uncovered measurement tank. Other conditions were set as described in Test Example 1.

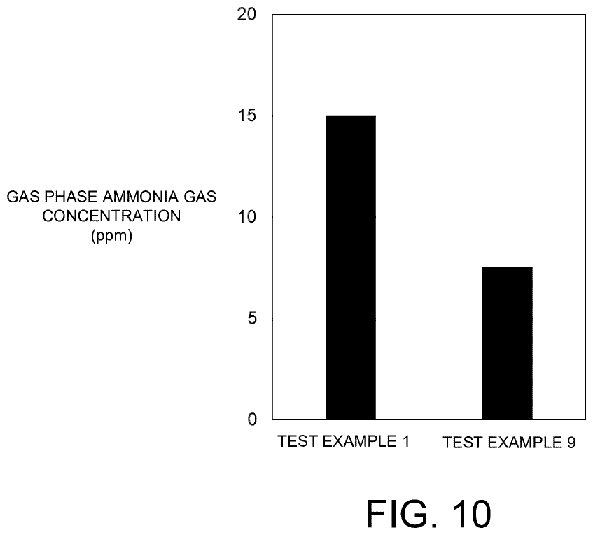

FIG. 10 illustrates the measurement result for the ammonia gas concentration in the gas phase of the covered measurement tank of Test Example 1, and the measurement result for the ammonia gas concentration in the gas phase of the uncovered measurement tank of Test Example 9. As illustrated in FIG. 10, dilution of the ammonia gas is better suppressed by conducting the measurement of the ammonia gas concentration in the gas phase using a covered measurement tank.

### SUPPLEMENTARY NOTES

(1)

A water treatment method having
a biological treatment step of biologically treating, in a biological treatment tank, a water to be treated containing dissolved ammonia nitrogen,
a first measurement step of introducing a portion of the water to be treated flowing into the biological treatment tank into a first measurement tank as a first sample liquid, transferring the ammonia nitrogen dissolved in the first sample liquid, under alkaline conditions, into the gas phase of the first measurement tank as ammonia gas, and measuring the ammonia gas concentration C₁,
a second measurement step of introducing a portion of the treated water that has undergone biological treatment in the biological treatment tank into a second measurement tank as a second sample liquid, transferring the ammonia nitrogen dissolved in the second sample liquid, under alkaline conditions, into the gas phase of the second measurement tank as ammonia gas, and measuring the ammonia gas concentration C₂, and
a control step of controlling the operating conditions for the biological treatment step on the basis of the ammonia gas concentration C₁ and the ammonia gas concentration C₂.
   (2)

The water treatment method according to (1) above, wherein
the control step controls the operating conditions for the biological treatment step on the basis of the ammonia removal rate, which is determined by dividing the ammonia nitrogen concentration in the treated water, estimated from the ammonia gas concentration C₂, by the ammonia nitrogen concentration in the water to be treated, estimated from the ammonia gas concentration C₁.
   (3)

The water treatment method according to (2) above, also having
a flow rate measurement step of measuring the flow rate of the water to be treated flowing into the biological treatment tank, wherein
the control step controls the operating conditions for the biological treatment step on the basis of the ammonia removal rate and the inflow ammonia load, which is determined by multiplying the ammonia nitrogen concentration in the water to be treated by the flow rate of the water to be treated.
   (4)

The water treatment method according to any one of (1) to (3) above, wherein
the hydraulic retention time in the first measurement tank and the hydraulic retention time in the second measurement tank are each not more than ¼ of the hydraulic retention time in the biological treatment tank.
   (5)

The water treatment method according to any one of (1) to (4) above, wherein
the operating conditions for the biological treatment step include at least one of the flow rate of the water to be treated flowing into the biological treatment tank, the temperature inside the biological treatment tank, the pH inside the biological treatment tank, the inorganic carbon concentration in the biological treatment tank, and the sludge concentration in the biological treatment tank.
   (6)

A water treatment apparatus having
a biological treatment tank for biologically treating a water to be treated containing dissolved ammonia nitrogen,
a first measurement device which has a first measurement tank and introduces a portion of the water to be treated flowing into the biological treatment tank into the first measurement tank as a first sample liquid, transfers the ammonia nitrogen dissolved in the first sample liquid, under alkaline conditions, into the gas phase of the first measurement tank as ammonia gas, and measures the ammonia gas concentration C₁,
a second measurement step which has a second measurement tank and introduces a portion of the treated water that has undergone biological treatment in the biological treatment tank into the second measurement tank as a second sample liquid, transfers the ammonia nitrogen dissolved in the second sample liquid, under alkaline conditions, into the gas phase of the second measurement tank as ammonia gas, and measures the ammonia gas concentration C₂, and
a control device for controlling the operating conditions for the biological treatment in the biological treatment tank on the basis of the ammonia gas concentration C₁ and the ammonia gas concentration C₂.
   (7)

The water treatment apparatus according to (6) above, wherein
the control device controls the operating conditions for the biological treatment in the biological treatment tank on the basis of the ammonia removal rate, which is determined by dividing the ammonia nitrogen concentration in the treated water, estimated from the ammonia gas concentration C₂, by the ammonia nitrogen concentration in the water to be treated, estimated from the ammonia gas concentration C₁.
   (8)

The water treatment apparatus according to (7) above, also having
a flow rate measurement device for measuring the flow rate of the water to be treated flowing into the biological treatment tank, wherein
the control device controls the operating conditions for the biological treatment in the biological treatment tank on the basis of the ammonia removal rate and the inflow ammonia load, which is determined by multiplying the ammonia nitrogen concentration in the water to be treated by the flow rate of the water to be treated.
   (9)

The water treatment apparatus according to any one of (6) to (8) above, wherein
the hydraulic retention time in the first measurement tank and the hydraulic retention time in the second measurement tank are each not more than ¼ of the hydraulic retention time in the biological treatment tank.
   (10)

The water treatment apparatus according to any one of (6) to (9) above, wherein
the operating conditions for the biological treatment in the biological treatment tank include at least one of the flow rate of the water to be treated flowing into the biological treatment tank, the temperature inside the biological treatment tank, the pH inside the biological treatment tank, the inorganic carbon concentration in the biological treatment tank, and the sludge concentration in the biological treatment tank.

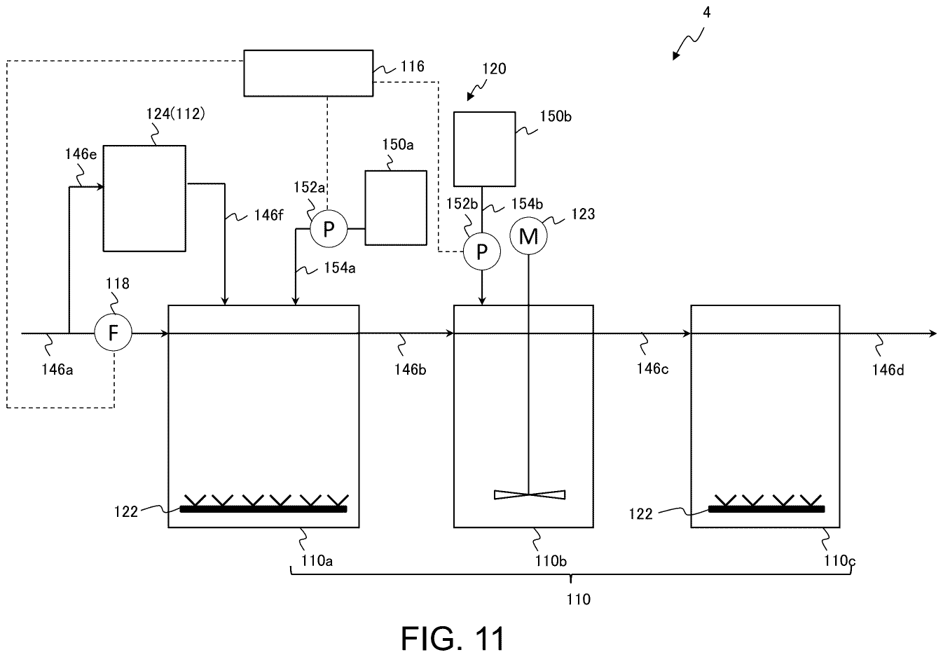

Next, using FIG. 11 to FIG. 18, a water treatment method and a water treatment apparatus are described which, during the biological treatment of a water to be treated containing dissolved ammonia nitrogen, enable an appropriate amount of nutrients to be supplied. These embodiments are merely examples of implementing the present invention, and the present invention is not limited to these embodiments.

FIG. 11 is a schematic structural diagram illustrating one example of a water treatment apparatus according to an embodiment of the present invention. The water treatment apparatus 4 illustrated in FIG. 4 has a biological treatment tank 110, a measurement device 112, a control device 116, a flow rate meter 118, and a nutrient supply device 120. The biological treatment tank 110 includes a nitrification tank 110a, a denitrification tank 110b, and an oxidation tank 110c. Aerators 122 are installed in the bottom of both the nitrification tank 110a and the oxidation tank 110c. Further, a stirrer 123 is installed in the denitrification tank 110b. For the measurement device 112 illustrated in FIG. 11, only a measurement tank 124 is drawn, with other components being omitted.

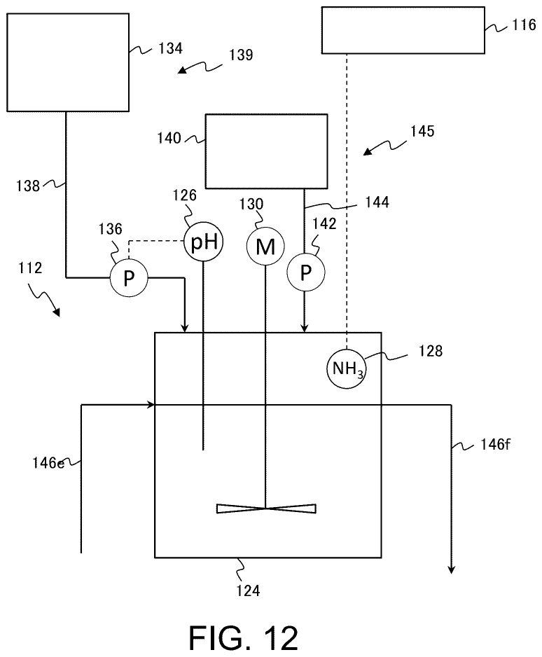

FIG. 12 is a schematic structural diagram illustrating one example of the measurement device. The measurement device 112 has a measurement tank 124, a pH meter 126, an ammonia gas concentration meter 128, and a stirrer 130. The ammonia gas concentration meter 128 is installed within the gas phase section of the measurement tank 124. The ammonia gas concentration meter 128 may also be installed within a line connected to the gas phase section of the measurement tank 124.

Further, the measurement device 112 has a pH regulator supply device. This pH regulator supply device has, for example, an alkaline agent supply device 139 equipped with an alkaline agent storage tank 134, an alkaline agent supply pump 136, and an alkaline agent supply line 138, and an acid agent supply device 145 equipped with an acid agent storage tank 140, an acid agent supply pump 142, and an acid agent supply line 144. The pH meter 126 and the alkaline agent supply pump 136 are electrically connected, either via wiring or wirelessly. The alkaline agent supply pump 136 may be operated, for example, by reading the pH value from the pH meter 126, and then ensuring that the inside of the measurement tank 124 is maintained under alkaline conditions.

A line 146a is connected to the nitrification tank 110a. The flow rate meter 118 is installed in the line 146a. Further, one end of a line 146b is connected to the nitrification tank 110a, and the other end of the line 146b is connected to the denitrification tank 110b. Furthermore, one end of a line 146c is connected to the denitrification tank 110b, and the other end of the line 146c is connected to the oxidation tank 110c. Further, a line 146d is connected to the oxidation tank 110c. One end of a line 146e is connected to the line 146a, and the other end of the line 146e is connected to the measurement tank 124. One end of a line 146f is connected to the measurement tank 124, and the other end of the line 146f is connected to the nitrification tank 110a.

One end of the alkaline agent supply line 138 is connected to the alkaline agent storage tank 134, and the other end of the alkaline agent supply line 138 is connected to the measurement tank 124. The alkaline agent supply pump 136 is installed in the alkaline agent supply line 138. One end of the acid agent supply line 144 is connected to the acid agent storage tank 140, and the other end of the acid agent supply line 144 is connected to the measurement tank 124. The acid agent supply pump 142 is installed in the acid agent supply line 144.

The nutrient supply device 120 includes nutrient storage tanks 150a and 150b, nutrient supply pumps 152a and 152b, and nutrient supply lines 154a and 154b. One end of the nutrient supply line 154a is connected to the nutrient storage tank 150a, and the other end of the nutrient supply line 154a is connected to the nitrification tank 110a. Further, one end of the nutrient supply line 154b is connected to the nutrient storage tank 150b, and the other end of the nutrient supply line 154b is connected to the denitrification tank 110b. The nutrient supply pump 152a is installed in the nutrient supply line 154a, and the nutrient supply pump 152b is installed in the nutrient supply line 154b. The nutrient supply device 120 of this embodiment may be configured in any manner that enables supply of nutrients to the biological treatment tank 110, and the invention is not limited to the particular configuration described above, although in cases such as that illustrated in FIG. 11, where the biological treatment tank 110 includes the nitrification tank 110a, the denitrification tank 110b and the oxidation tank 110c, the nutrient supply device 120 is preferably configured to supply nutrients to at least one of the nitrification tank 110a and the denitrification tank 110b. Examples of the nutrients include phosphorus sources, hydrogen donors, and trace metals and the like.

The control device 116 is electrically connected, either by wiring or wirelessly, to the ammonia gas concentration meter 128, the flow rate meter 118, and the nutrient supply pumps 152a and 152b. The control device 16 is, for example, composed of a microcomputer comprising a CPU that executes programs and ROM and RAM that store programs and operational results, and electrical circuits and the like, and the control device 16 reads a prescribed program stored in ROM or the like, and executes that program to control the operation of the water treatment apparatus 4. Although described in more detail below, for example, the control device 16 may control the operation of the nutrient supply pumps 152a and 152b on the basis of the ammonia nitrogen concentration in the water to be treated and the flow rate of the water to be treated.

A description of one example of the operation of the water treatment apparatus 4 according to this embodiment is described below.

The water to be treated containing dissolved ammonia nitrogen flows into the biological treatment tank 110 and is subjected to a biological treatment (the biological treatment step). For example, the water to be treated containing dissolved ammonia nitrogen flows from the line 146a into the nitrification tank 110a. Inside the nitrification tank 110a, an oxygen-containing gas such as air is supplied by the aerator 122, thereby mixing the water to be treated and the sludge containing the microbes, and enabling a nitrification treatment such as that represented by the above formula 1 to proceed under aerobic conditions. During the nitrification treatment, the nutrient supply pump 152a is activated, and the nutrients inside the nutrient storage tank 150a are supplied as appropriate from the nutrient supply line 154a to the nitrification tank 110a (a nutrient supply step). The treated water that has undergone the nitrification treatment flows through the line 146b into the denitrification tank 110b. In the denitrification tank 110b, the treated water that has undergone the nitrification treatment and the sludge containing the microbes are mixed using the stirrer 123, enabling a denitrification treatment such as that represented by the above formula 2 to proceed under anaerobic conditions. During the denitrification treatment, the nutrient supply pump 152b is activated, and the nutrients inside the nutrient storage tank 150b are supplied as appropriate from the nutrient supply line 154b to the denitrification tank 110b (a nutrient supply step). Control of the amount supplied of the nutrients is described below.

Furthermore, the treated water that has undergone the denitrification treatment flows through the line 146c and into the oxidation tank 110c. Inside the oxidation tank 110c, an oxygen-containing gas such as air is supplied by the aerator 122, and an oxidation treatment that removes organic matter contained in the treated water is conducted under aerobic conditions. The treated water that has undergone treatment in the oxidation tank 110c is discharged from the line 146d.

Furthermore, in this embodiment, a portion of the water to be treated flowing through the line 146a flows from the line 146e into the measurement tank 124 as a sample liquid. The pH of the sample liquid is measured as required by the pH meters 126, and the alkaline agent supply pump 136 is operated on the basis of the measured pH value. By activating the alkaline agent supply pump 136, a prescribed amount of the alkaline agent is supplied from the alkaline agent storage tank 134 to the measurement tank 124, enabling the inside of the measurement tank 124 to be maintained under alkaline conditions. In the measurement tank 124, the sample liquid and the alkaline agent are stirred by the stirrer 130.

In the measurement tank 124, alkaline conditions are established, the ammonia nitrogen dissolved in the sample liquid migrates into the gas phase as ammonia gas (NH₃), and the ammonia gas concentration is measured by the ammonia gas concentration meter 128 (the measurement step).

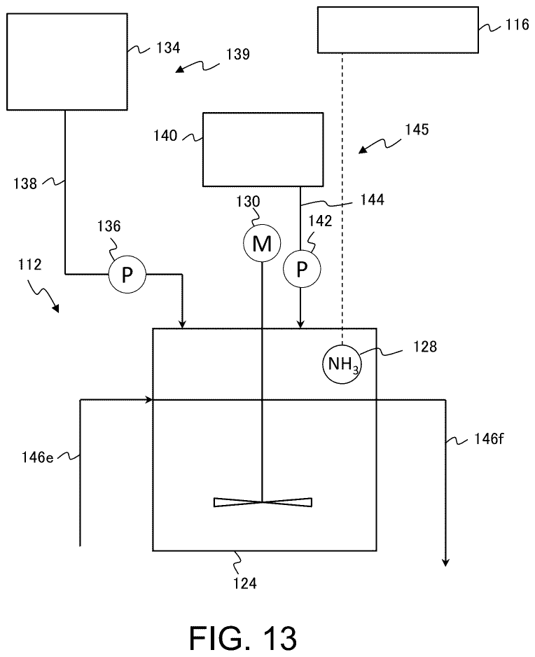

FIG. 13 is a schematic structural diagram illustrating another example of the measurement device 112. The measurement device 112 illustrated in FIG. 13 is not equipped with a pH meter. In this measurement device 112, the alkaline agent is added in a fixed ratio relative to the water inflow rate, thereby ensuring alkaline conditions inside the tank, and the ammonia gas concentration is measured by the ammonia gas concentration meter 128.

The ammonia nitrogen in the sample liquid exists as NH₃ and NH₄+, and the equilibrium relationship is represented by the formula shown below.

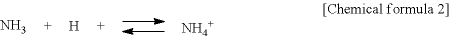

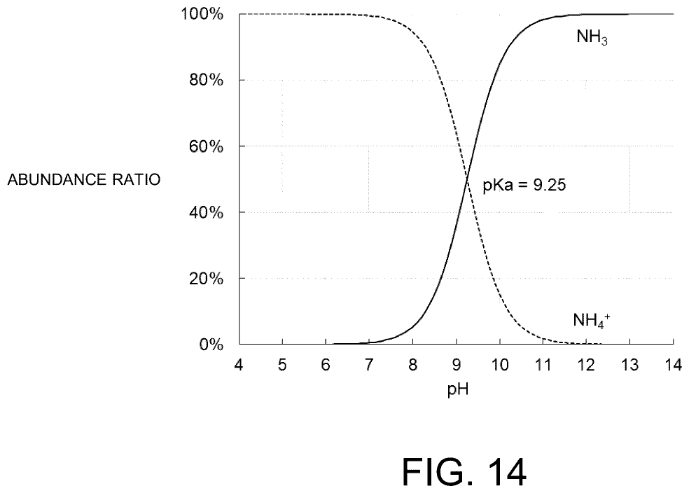

FIG. 14 illustrates the abundance ratios of NH₃ and NH₄⁺ at various pH values. The acid dissociation constant (pKa) for NH₄⁺ is 9.25, and the abundance ratio of NH₃ in the dissolved ammonia nitrogen is 8% at pH 8, 36% at pH 9, 85% at pH 10, and 98% at pH 11. A portion of the dissolved NH₃ volatilizes as ammonia gas (NH₃ gas). If the abundance ratio of NH₃ is high, then the amount of NH₃ that volatilizes as ammonia gas also increases. The inside of the measurement tank may be set at any level of alkalinity, but in terms of enabling the ammonia gas to be measured easily with the ammonia gas concentration meter even when the concentration of dissolved ammonia nitrogen is low, the pH inside the measurement tank is preferably at least 10, and more preferably 11 or higher.

The control device 116 controls the amount of nutrients supplied to the biological treatment tank on the basis of the ammonia nitrogen concentration in the water to be treated estimated from the ammonia gas concentration, and the flow rate of the water to be treated (the control step). One example of this control method is described below.

Information on the correlation between the dissolved ammonia nitrogen concentration and the ammonia gas concentration is first stored in the control device 116 in advance. Then, using that correlation information, the control device 116 determines the dissolved ammonia nitrogen concentration (this refers to the ammonia nitrogen concentration in the water to be treated) from the ammonia gas concentration detected by the ammonia gas concentration meter 128. The flow rate of the water to be treated flowing through the line 146a is measured by the flow rate meter 118 (a flow rate measurement step) and transmitted to the control device 116. Based on the ammonia nitrogen concentration in the water to be treated and the flow rate of the water to be treated detected by the flow rate meter 118, the control device 116 calculates the optimal addition amount for the nutrients. For example, in those cases where all of the ammonia nitrogen is oxidized to nitrate nitrogen in the nitrification tank 110a, and methanol is used as a hydrogen donor nutrient, the optimal nutrient addition amount is preferably an amount of methanol that is three times the amount of ammonia nitrogen in the water to be treated. For example, the control device 116 calculates the amount of methanol to be supplied to the denitrification tank 110b as [ammonia nitrogen concentration in the water to be treated estimated from the ammonia gas concentration]×flow rate of water to be treated×3 (although a 3-fold amount is preferred, the invention is not limited to a 3-fold amount). In a similar manner, the amount of trace metals to be added to the nitrification tank can be calculated as ammonia nitrogen concentration in the water to be treated×flow rate of water to be treated×prescribed multiplication factor for nitrification. Similarly, in the case of a phosphorus source, the amount of ammonia in the water to be treated may be multiplied by a prescribed multiplication factor, which is set in advance for nitrification and denitrification respectively, to determine the addition amount. The control device 116 conducts inverter control of the nutrient supply pumps 152a and 152b, thereby supplying the calculated amount of the various nutrients to the nitrification tank 110a and the denitrification tank 110b. In those cases where the water to be treated contains nutrients, an amount of nutrients calculated by subtracting the amount of nutrients already in the water to be treated from the aforementioned calculated addition amount is preferably supplied. The concentration of nutrients in the water to be treated may be a manually analyzed value, or a value acquired from an online sensor.

Further, another example of the control method is described below. For example, in the same manner as described above, the control device 116 first calculates the ammonia nitrogen concentration in the water to be treated from the ammonia gas concentration detected by the ammonia gas concentration meter 128. Then, in those cases where the inflow ammonia load, which is determined by multiplying the ammonia nitrogen concentration in the water to be treated by the flow rate of the water to be treated detected by the flow rate meter 118, differs from a preset planned value, the control device 116 activates the nutrient supply pumps 152a and 152b, and begins supply of the nutrients. Alternatively, when the inflow ammonia load differs from the preset planned value, the control device 116 may increase the output of the nutrient supply pumps 152a and 152b, thereby increasing the amount of nutrients being supplied. Subsequently, when the inflow ammonia load falls back within the preset planned value range, the control device 116 either halts operation of the nutrient supply pumps 152a and 152b, or reduces the output of the nutrient supply pumps 152a and 152b, returning the supply of nutrients to the original state. The control device 116 may also perform inverter control of the nutrient supply pumps 152a and 152b so as to increase or decrease the amount of nutrients being supplied in accordance with increase or decrease in the inflow ammonia load. The planned value for the inflow ammonia load is, for example, preferably a range from 0.1 to 0.3 kg-N/m³/day in the case of an activated sludge method, and is, for example, preferably a range from 0.5 to 1.0 kg-N/m³/day in the case of a biofilm method (for example, a fixed bed system or moving bed system) or a granular method.

In this manner, by controlling the amount of nutrients supplied to the biological treatment tank on the basis of the ammonia nitrogen concentration in the water to be treated, estimated from the ammonia gas concentration detected on the side of the water to be treated, and the flow rate of the water to be treated flowing into the biological treatment tank, even if, for example, the ammonia nitrogen concentration in the water to be treated fluctuates, that fluctuation in concentration can be ascertained rapidly and an appropriate amount of nutrients can be supplied. As a result, the water to be treated containing dissolved ammonia nitrogen can be biologically treated in a stable manner. In this embodiment, because non-contact ammonia gas concentration meters are used for the treated water and the water to be treated containing dissolved ammonia nitrogen, there is no need to clean soiling or scale from the sensor portions of the concentration meters, making maintenance simple.

Next are detailed descriptions of the biological treatment tank 110, the measurement device 112 and the nutrients and the like.

The biological treatment tank 110 may adopt any configuration, provided it is capable of biologically treating the water to be treated containing dissolved ammonia nitrogen. Examples include biological treatment tanks or the like that conduct biological treatment of a water to be treated containing dissolved ammonia nitrogen using an activated sludge method, a membrane bioreactor method (MBR), a fixed bed or moving bed biofilm method, or a granular method. Further, examples of the biological treatment of the water to be treated containing dissolved ammonia nitrogen include nitrification methods, nitrification/denitrification methods, circulating nitrification/denitrification methods, and anaerobic ammonia oxidation methods (for example, the anammox method). The biological treatment tank 110 may be composed of a single tank or a plurality of tanks. Examples of multiple tank configurations include tank configurations that include a nitrification tank 110a and a denitrification tank 110b, tank configurations that include a plurality of nitrification tanks 110a, and tank configurations that include a plurality of denitrification tanks 110b.

The measurement tank 124 that constitutes part of the measurement device 112 preferably has a closed cover. By covering the measurement tank 124, dilution of the ammonia gas concentration due to ingress of air is suppressed, meaning the ammonia gas detection sensitivity of the ammonia gas concentration meter can be improved.

A heater is preferably installed in the measurement tank 124 to heat the inside of the measurement tank 124. This enables the ammonia gas concentration in the gas phase inside the measurement tank 124 to be increased. Further, the gas phase inside the measurement tank 124 may also be circulated using a blower. In such cases, the measurement tank 124 is preferably totally sealed. In order to prevent ingress of air into the measurement tank 124, the line 146f connected to the measurement tank 124 is preferably water sealed. For example, the line 146f may be water sealed by providing a water tank filled with water in the line, by extending the line 146f to a position lower than the water level in the biological treatment tank 110, or by forming the line 146f with an S-bend.

The inflow of the sample liquid into the measurement tank 124 may be continuous or intermittent.

The hydraulic retention time in the measurement tank 124 is preferably not more than ¼ of the hydraulic retention time in the biological treatment tank 110. By ensuring that the hydraulic retention time in the measurement tank 124 is not more than ¼ of the hydraulic retention time in the biological treatment tank 110, for example, the ability to conform to the ammonia nitrogen concentration in the water to be treated improves, and control of the amount added of the nutrients becomes easier. Here, the hydraulic retention time in the biological treatment tank represents the hydraulic retention time until the water reaches the tank in which the treatment state of the ammonia nitrogen concentration is to be followed. In other words, in those cases where the treatment state up until the nitrification tank is to be ascertained, the hydraulic retention time in the measurement tank is ¼ of the hydraulic retention time in the nitrification tank. When the treatment state up until the denitrification tank is to be ascertained, the hydraulic retention time represents the total hydraulic retention time in the nitrification tank and the denitrification tank.

In order to avoid condensation on the ammonia gas concentration meter 128, a mist separator may be installed in front of the ammonia gas concentration meter 128. Examples of the ammonia gas concentration meter 128 include electrochemical, semiconductor-based and contact combustion-type ammonia gas concentration meters. Measurement of the ammonia gas concentration may be conducted online or manually.

The sample liquid discharged from the measurement tank 124 is preferably returned to the nitrification tank 110a under alkaline conditions. In the nitrification tank 110a, alkali is consumed, for example, in accordance with the above formula 2. Accordingly, by returning the sample liquid discharged from the measurement tank 124 via the line 146f to the nitrification tank 110a, the nitrification tank 110a can be replenished with alkali. Examples of the alkaline agent supplied to the measurement tank 124 for ammonia gas measurement include sodium hydroxide, potassium hydroxide and calcium hydroxide.

Scale may sometimes be deposited inside the measurement tank 124, and therefore the inside of the tank is preferably washed periodically. For example, the acid agent supply pump 142 may be activated periodically (for example, once per day), thereby supplying a prescribed amount of an acid agent from the acid agent storage tank 140 to the measurement tank 124 to remove the scale and wash the inside of the tank.

The wastewater produced following supply of the acid agent to the measurement tank 124 to wash the inside of the tank is, for example, preferably supplied to the denitrification tank 110b. As shown in formula 2 above, alkali is produced in the denitrification tank 110b, and therefore by supplying the wastewater produced following scale removal from inside the measurement tank 124 to the denitrification tank 110b, the denitrification tank 110b can be replenished with acid. Examples of the acid supplied to the measurement tank 124 for washing the inside of the tank include hydrochloric acid, sulfuric acid, nitric acid, phosphoric acid, citric acid, oxalic acid, lactic acid, ascorbic acid and malic acid. Among these, hydrochloric acid or nitric acid is preferred, as each enables a large reduction in the pH with a small amount of added acid.

Control of the amount of nutrients added is not limited to the case where the nutrient supply pumps 152a and 152b are controlled, and may also be achieved, for example, by adjusting the degree of opening of valves installed in the nutrient supply lines 154a and 154b.

The location to which the nutrients are added may be the biological treatment tank 110 (for example, the nitrification tank 110a or the denitrification tank 110b), or a line (for example, the line 146a or 146b) that is connected to the biological treatment tank 110.

Examples of the nutrients include phosphorus sources, trace metals, and hydrogen donors and the like. Examples of the phosphorus sources include phosphoric acid and phosphate salts. Examples of the trace metals include alkali metals such as sodium, potassium, calcium and magnesium, and other metals such as iron, manganese, zinc, and nickel. Conventional substances may be used as the hydrogen donors, and specific examples include methanol, ethanol, isopropanol, acetic acid, hydrogen gas, acetone, glucose, and ethyl methyl ketone.

### Test Example 11

A simulated wastewater containing ammonia nitrogen (1 to 50 mg-N/L), calcium (400 mg-Ca/L), inorganic carbon (20 mg-C/L), phosphorus (1 mg-P/L) and trace metals was flowed through a covered measurement tank having a liquid phase volume of 1 L and a gas phase volume of 0.4 L with a hydraulic retention time (HRT) of 10 minutes. A 25% sodium hydroxide solution was added to the tank in an amount sufficient to adjust the pH inside the measurement tank to 11 or higher, and the solution in the tank was thoroughly mixed with a stirrer. The water temperature was set to a value of 20 to 23° C., and under normal atmospheric pressure, 30 minutes after the introduction of the simulated wastewater into the tank, the ammonia gas concentration that had migrated into the gas phase of the measurement tank was measured using an ammonia gas sensor. Further, the ammonia nitrogen concentration in the simulated wastewater was measured using the indophenol blue absorption spectrophotometry method.

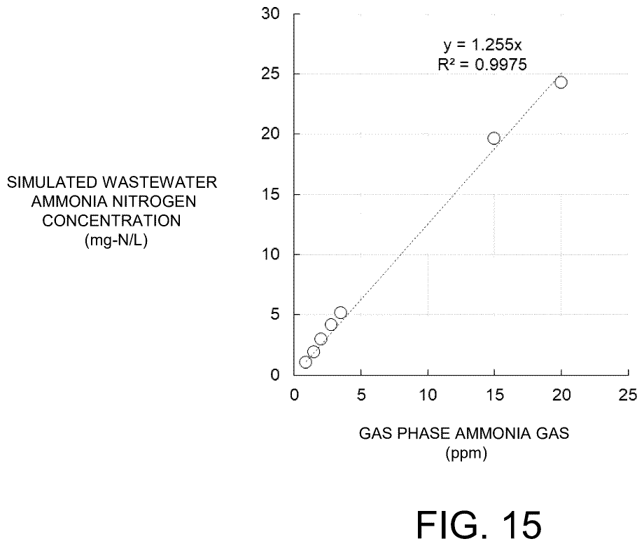

FIG. 15 illustrates the relationship between the ammonia nitrogen concentration in the simulated wastewater and the ammonia gas concentration in the gas phase in Test Example 11. As illustrated in FIG. 15, the ammonia nitrogen concentration in the simulated wastewater and the ammonia gas concentration in the gas phase exhibit a positive correlation (coefficient of determination R²=0.9956). Accordingly, it was evident that by using an approximation expression, the ammonia nitrogen concentration in the simulated wastewater could be calculated from the ammonia gas concentration in the gas phase.

### Test Example 12

A simulated wastewater containing an ammonia nitrogen concentration of 20 mg-N/L and a calcium concentration of 0 to 400 mg-Ca/L was flowed through the measurement tank. Other conditions were set as described in Test Example 11.

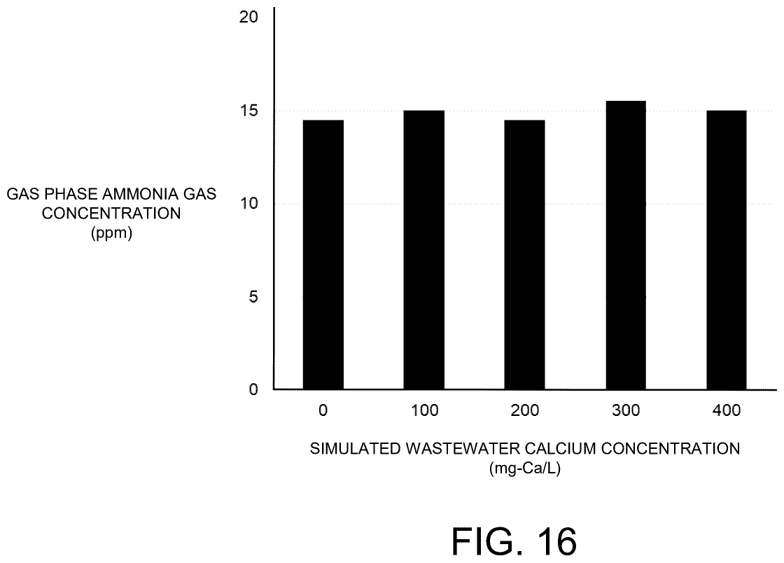

FIG. 16 illustrates the ammonia gas concentration in the gas phase for various calcium concentrations (0 to 400 mg-Ca/L) in the simulated wastewater of Test Example 12. As illustrated in FIG. 16, even when the calcium concentration in the simulated wastewater changes, there is almost no effect on the ammonia gas concentration in the gas phase. For example, an ammonia nitrogen-containing wastewater discharged from a semiconductor plant also contains fluorine. Fluorine has an adverse effect on the biological treatment, and therefore the nitrification/denitrification treatment step is preferably conducted after removal of the fluorine. In the step of removing the fluorine, the fluorine is reacted with a calcium compound to precipitate calcium fluoride, but in order to ensure satisfactory removal of the fluorine, a substantial amount of calcium is preferably added. As a result, the ammonia nitrogen-containing wastewater flowing into the nitrification/denitrification treatment may sometimes contain calcium ions in a concentration of 100 mg-Ca/L or higher. However, as verified in Test Example 12, because the ammonia gas concentration in the gas phase is independent of the calcium ion concentration in the wastewater, there is no need to conduct a pretreatment to remove the calcium from the wastewater when measuring the ammonia gas concentration.

### Test Example 13

A simulated wastewater containing an ammonia nitrogen concentration of 20 mg-N/L was flowed through the measurement tank with an HRT of 10 minutes. At 0 minutes, 5 minutes, 10 minutes, 15 minutes, 30 minutes, 45 minutes, and 60 minutes after the start of the inflow, the ammonia gas concentration in the gas phase was measured. Other conditions were set as described in Test Example 11.

### Test Example 14

A simulated wastewater containing an ammonia nitrogen concentration of 20 mg-N/L was flowed through the measurement tank with an HRT of 5 minutes. At 0 minutes, 2.5 minutes, 5 minutes, 10 minutes, 15 minutes, 20 minutes, and 30 minutes after the start of the inflow, the ammonia gas concentration in the gas phase was measured. Other conditions were set as described in Test Example 11.

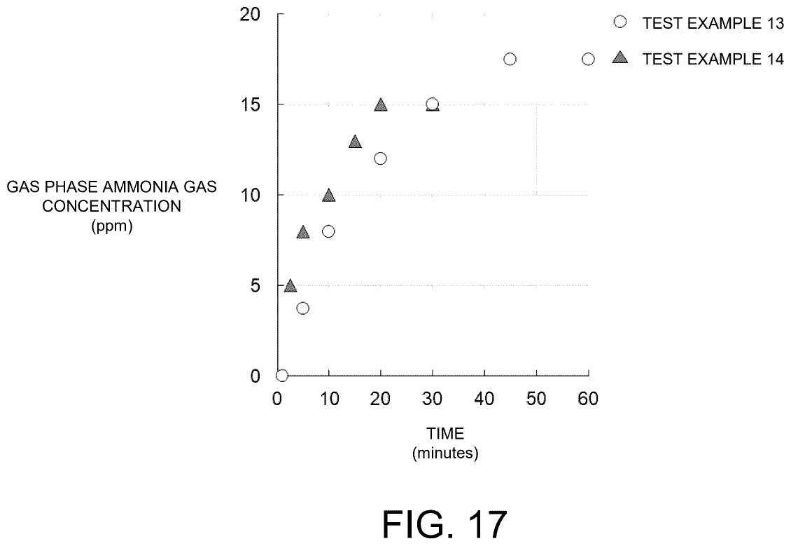

FIG. 17 illustrates the change over time in the ammonia gas concentration in the gas phase in Test Examples 13 and 14. As illustrated in FIG. 17, in order for the ammonia gas concentration in the gas phase to reach a maximum value, a time that was 4 times the measurement tank HRT was required. Because it is preferable that the NH₃ gas concentration reaches a maximum value at least once within 1 HRT for the biological treatment tank, the HRT for the measurement tank is preferably set to not more than ¼ of the HRT for the biological treatment tank. The measurement tank HRT can be increased or decreased by controlling the inflow rate of the simulated wastewater into the measurement tank. Provided the measurement tank is sufficiently small compared with the biological treatment tank, the inflow rate of the simulated wastewater may be low, and the pump used for supplying the simulated wastewater to the measurement tank can be reduced in size.

### Test Example 15

A semiconductor plant wastewater containing ammonia nitrogen was introduced into the measurement tank. Other conditions were set as described in Test Example 11. Based on the actual measured value for the ammonia nitrogen concentration in the semiconductor plant wastewater measured using the indophenol blue absorption spectrophotometry method, and the measured value for the ammonia gas concentration in the gas phase, a correlation was confirmed using this wastewater in the same manner as described in Test Example 11, and the relative error in the value for the ammonia nitrogen concentration calculated using the obtained approximation expression was 13%. These results confirmed that the ammonia gas concentration in the gas phase, measured without first filtering the wastewater, could be used to calculate the ammonia nitrogen concentration in a semiconductor plant wastewater.

### Test Example 16

A 20% hydrochloric acid solution was added to the measurement tank used in Test Example 11, thereby reducing the pH inside the tank to 2 or lower, and the solution inside the tank was stirred for 5 minutes. As a result, scale that had been deposited inside the tank under the alkaline conditions was dissolved.

### Test Example 17

A simulated wastewater containing an ammonia nitrogen concentration of 20 mg-N/L was flowed through an uncovered measurement tank. Other conditions were set as described in Test Example 1.

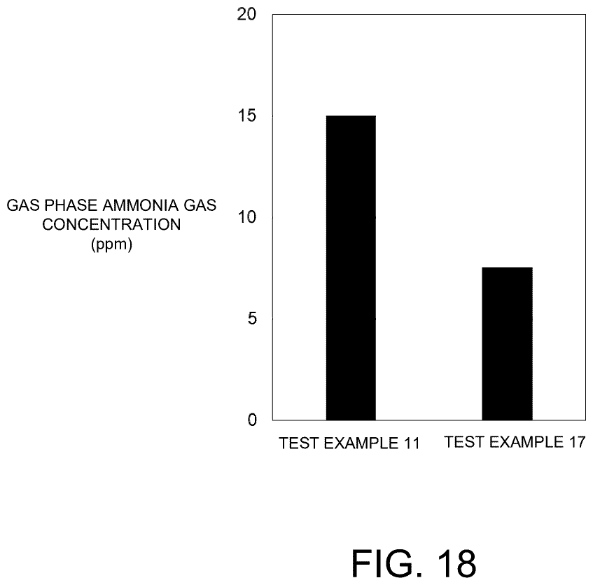

FIG. 18 illustrates the measurement result for the ammonia gas concentration in the gas phase of the covered measurement tank of Test Example 11, and the measurement result for the ammonia gas concentration in the gas phase of the uncovered measurement tank of Test Example 17. As illustrated in FIG. 18, dilution of the ammonia gas is better suppressed by conducting the measurement of the ammonia gas concentration in the gas phase using a covered measurement tank.

### SUPPLEMENTARY NOTES

(1)

A water treatment method having
a biological treatment step of biologically treating, in a biological treatment tank, a water to be treated containing dissolved ammonia nitrogen,
a nutrient supply step of supplying a nutrient to the biological treatment tank,
a flow rate measurement step of measuring the flow rate of the water to be treated flowing into the biological treatment tank,
a measurement step of introducing a portion of the water to be treated flowing into the biological treatment tank into a measurement tank as a sample liquid, transferring the ammonia nitrogen dissolved in the sample liquid, under alkaline conditions, into the gas phase of the measurement tank as ammonia gas, and measuring the ammonia gas concentration, and
a control step of controlling the amount supplied of the nutrient on the basis of the ammonia nitrogen concentration in the water to be treated estimated from the ammonia gas concentration, and the flow rate of the water to be treated.
   (2)

The water treatment method according to (1) above, wherein
the hydraulic retention time in the measurement tank is not more than ¼ of the hydraulic retention time in the biological treatment tank.
   (3)

The water treatment method according to (1) or (2) above, wherein
the nutrient contains at least one of a phosphorus source, a trace metal and a hydrogen donor.
   (4)

The water treatment method according to any one of (1) to (3) above, also having
an acid agent supply step of supplying an acid agent to the measurement tank and washing the inside of the measurement tank.
   (5)

A water treatment apparatus having
a biological treatment tank for biologically treating a water to be treated containing dissolved ammonia nitrogen,
a nutrient supply device for supplying a nutrient to the biological treatment tank,
a measurement device which has a measurement tank and introduces a portion of the water to be treated flowing into the biological treatment tank into the measurement tank as a sample liquid, transfers the ammonia nitrogen dissolved in the sample liquid, under alkaline conditions, into the gas phase of the measurement tank as ammonia gas, and measures the ammonia gas concentration, and
a control device for controlling the amount supplied of the nutrient on the basis of the ammonia nitrogen concentration in the water to be treated estimated from the ammonia gas concentration, and the flow rate of the water to be treated.
   (6)

The water treatment apparatus according to (5) above, wherein
the hydraulic retention time in the measurement tank is not more than ¼ of the hydraulic retention time in the biological treatment tank.
   (7)

The water treatment apparatus according to (5) or (6) above, wherein
the nutrient contains at least one of a phosphorus source, a trace metal and a hydrogen donor.
   (8)

The water treatment apparatus according to any one of (5) to (7) above, also having
an acid agent supply device for supplying an acid agent to the measurement tank to wash the inside of the measurement tank.

### REFERENCE SIGNS LIST

1 to 4: Water treatment apparatus
10, 10a, 10b: Biological treatment tank
12: First measurement device
14: Second measurement device
16: Control device
18: Flow rate meter
20: Water to be treated supply pump
22: Aerator
24: First measurement tank
26a, 26b: pH meter
28a, 28b: Ammonia gas concentration meter
30: Stirrer
32: Second measurement tank
34: Alkaline agent storage tank
36a, 36b: Alkaline agent supply pump
38a, 38b: Alkaline agent supply line
39: Alkaline agent supply device
40: Acid agent storage tank
42a, 42b: Acid agent supply pump
44a, 44b: Acid agent supply line
45: Acid agent supply device
46a to 46f, 46k, 46m, 46n, 46p: Line
50: Single measurement device
52: Single measurement tank
110: Biological treatment tank
110a: Nitrification tank
110b: Denitrification tank
110c: Oxidation tank
112: Measurement device
116: Control device
118: Flow rate meter
120: Nutrient supply device
122: Aerator
123, 130: Stirrer
124: Measurement tank
126: pH meter
128: Ammonia gas concentration meter
134: Alkaline agent storage tank
136: Alkaline agent supply pump
138: Alkaline agent supply line
139: Alkaline agent supply device
140: Acid agent storage tank
142: Acid agent supply pump
144: Acid agent supply line
145: Acid agent supply device
146a to 146f: Line
150a, 150b: Nutrient storage tank
152a, 152b: Nutrient supply pump
154a, 154b: Nutrient supply line

1. A water treatment method having
a biological treatment step of biologically treating, in a biological treatment tank, a water to be treated containing dissolved ammonia nitrogen,
a first measurement step of introducing a portion of the water to be treated flowing into the biological treatment tank into a first measurement tank as a first sample liquid, transferring the ammonia nitrogen dissolved in the first sample liquid, under alkaline conditions, into a gas phase of the first measurement tank as ammonia gas, and measuring an ammonia gas concentration C₁,
a second measurement step of introducing a portion of a treated water that has undergone biological treatment in the biological treatment tank into a second measurement tank as a second sample liquid, transferring the ammonia nitrogen dissolved in the second sample liquid, under alkaline conditions, into a gas phase of the second measurement tank as ammonia gas, and measuring an ammonia gas concentration C₂, and
a control step of controlling operating conditions for the biological treatment step based on the ammonia gas concentration C₁ and the ammonia gas concentration C₂.

2. The water treatment method according to claim 1, wherein
the control step controls operating conditions for the biological treatment step based on an ammonia removal rate, which is determined by dividing an ammonia nitrogen concentration in the treated water, estimated from the ammonia gas concentration C₂, by an ammonia nitrogen concentration in the water to be treated, estimated from the ammonia gas concentration C₁.

3. The water treatment method according to claim 2, also having
a flow rate measurement step of measuring a flow rate of the water to be treated flowing into the biological treatment tank, wherein
the control step controls operating conditions for the biological treatment step based on the ammonia removal rate and an inflow ammonia load, which is determined by multiplying the ammonia nitrogen concentration in the water to be treated by the flow rate of the water to be treated.

4. The water treatment method according to claim 1, wherein
a hydraulic retention time in the first measurement tank and a hydraulic retention time in the second measurement tank are each not more than ¼ of a hydraulic retention time in the biological treatment tank.

5. The water treatment method according to claim 1, wherein
operating conditions for the biological treatment step include at least one of a flow rate of the water to be treated flowing into the biological treatment tank, a temperature inside the biological treatment tank, a pH inside the biological treatment tank, an inorganic carbon concentration in the biological treatment tank, and a sludge concentration in the biological treatment tank.

6. A water treatment apparatus having
a biological treatment tank for biologically treating a water to be treated containing dissolved ammonia nitrogen,
a first measurement device which has a first measurement tank and introduces a portion of the water to be treated flowing into the biological treatment tank into the first measurement tank as a first sample liquid, transfers the ammonia nitrogen dissolved in the first sample liquid, under alkaline conditions, into a gas phase of the first measurement tank as ammonia gas, and measures an ammonia gas concentration C₁,
a second measurement step which has a second measurement tank and introduces a portion of a treated water that has undergone biological treatment in the biological treatment tank into the second measurement tank as a second sample liquid, transfers the ammonia nitrogen dissolved in the second sample liquid, under alkaline conditions, into a gas phase of the second measurement tank as ammonia gas, and measures an ammonia gas concentration C₂, and
a control device for controlling operating conditions for the biological treatment in the biological treatment tank based on the ammonia gas concentration C₁ and the ammonia gas concentration C₂.

7. The water treatment apparatus according to claim 6, wherein
the control device controls operating conditions for the biological treatment in the biological treatment tank based on an ammonia removal rate, which is determined by dividing an ammonia nitrogen concentration in the treated water, estimated from the ammonia gas concentration C₂, by an ammonia nitrogen concentration in the water to be treated, estimated from the ammonia gas concentration C₁.

8. The water treatment apparatus according to claim 7, also having a flow rate measurement device for measuring a flow rate of the water to be treated flowing into the biological treatment tank, wherein
the control device controls operating conditions for the biological treatment in the biological treatment tank based on the ammonia removal rate and an inflow ammonia load, which is determined by multiplying the ammonia nitrogen concentration in the water to be treated by the flow rate of the water to be treated.

9. The water treatment apparatus according to claim 6, wherein
a hydraulic retention time in the first measurement tank and a hydraulic retention time in the second measurement tank are each not more than ¼ of a hydraulic retention time in the biological treatment tank.

10. The water treatment apparatus according to claim 6, wherein
operating conditions for the biological treatment in the biological treatment tank include at least one of a flow rate of the water to be treated flowing into the biological treatment tank, a temperature inside the biological treatment tank, a pH inside the biological treatment tank, an inorganic carbon concentration in the biological treatment tank, and a sludge concentration in the biological treatment tank.

11. A water treatment method having
a biological treatment step of biologically treating, in a biological treatment tank, a water to be treated containing dissolved ammonia nitrogen,
a nutrient supply step of supplying a nutrient to the biological treatment tank,
a flow rate measurement step of measuring a flow rate of the water to be treated flowing into the biological treatment tank,
a measurement step of introducing a portion of the water to be treated flowing into the biological treatment tank into a measurement tank as a sample liquid, transferring the ammonia nitrogen dissolved in the sample liquid, under alkaline conditions, into a gas phase of the measurement tank as ammonia gas, and measuring an ammonia gas concentration, and
a control step of controlling an amount supplied of the nutrient based on an ammonia nitrogen concentration in the water to be treated estimated from the ammonia gas concentration, and the flow rate of the water to be treated.

12. The water treatment method according to claim 11, wherein
a hydraulic retention time in the measurement tank is not more than ¼ of a hydraulic retention time in the biological treatment tank.

13. The water treatment method according to claim 11, wherein
the nutrient comprises at least one of a phosphorus source, a trace metal and a hydrogen donor.

14. The water treatment method according to claim 11, also having
an acid agent supply step of supplying an acid agent to the measurement tank and washing the inside of the measurement tank.

15. A water treatment apparatus having
a biological treatment tank for biologically treating a water to be treated containing dissolved ammonia nitrogen,
a nutrient supply device for supplying a nutrient to the biological treatment tank,
a measurement device which has a measurement tank and introduces a portion of the water to be treated flowing into the biological treatment tank into the measurement tank as a sample liquid, transfers the ammonia nitrogen dissolved in the sample liquid, under alkaline conditions, into a gas phase of the measurement tank as ammonia gas, and measures an ammonia gas concentration, and
a control device for controlling an amount supplied of the nutrient based on an ammonia nitrogen concentration in the water to be treated estimated from the ammonia gas concentration, and a flow rate of the water to be treated.

16. The water treatment apparatus according to claim 15, wherein
a hydraulic retention time in the measurement tank is not more than ¼ of a hydraulic retention time in the biological treatment tank.

17. The water treatment apparatus according to claim 15, wherein
the nutrient comprises at least one of a phosphorus source, a trace metal and a hydrogen donor.

18. The water treatment apparatus according to claim 15, also having
an acid agent supply device for supplying an acid agent to the measurement tank to wash the inside of the measurement tank.
